(19) United States
(12) Patent Application Publication
(10) Pub. No.: US 2026/0127779 A1
(43) Pub. Date: May 7, 2026

(54) COMPOSITIONAL TEXT-TO-VIDEO GENERATION WITH DENSE BLOB VIDEO REPRESENTATIONS

(71) Applicant: NVIDIA Corporation, Santa Clara, CA (US)

(72) Inventors: Weixi Feng, San Jose, CA (US); Weili Nie, Sunnyvale, CA (US); Chao Liu, Santa Clara, CA (US); Sifei Liu, Santa Clara, CA (US); Arash Vahdat, San Mateo, CA (US)

(21) Appl. No.: 19/064,477

(22) Filed: Feb. 26, 2025

Related U.S. Application Data
(60) Provisional application No. 63/715,087, filed on Nov. 1, 2024.
(60) Provisional application No. 63/742,553, filed on Jan. 7, 2025.

(51) Int. Cl. G06T 11/00; G06N 3/0455

(52) U.S. Cl. CPC G06T 11/00; G06N 3/0455

(57) ABSTRACT

Systems and methods are disclosed that generate blob video representations such as blob video parameters and blob video descriptions and use the blob video representations to generate videos. For example, embodiments of the present disclosure may decompose videos into visual primitives (e.g., blob video representations, which may be general representations for controllable video generation). Based on the blob video representations, a blob-grounded text-to-video diffusion model that includes masked three-dimensional (3D) self-attention layers and/or masked spatial cross-attention layers may be developed. The masked 3D self-attention layers and/or masked spatial cross-attention layers may effectively improve regional consistency across frames. Additionally, and/or alternatively, embodiments of the present disclosure may utilize context interpolation that may interpolate text embeddings. Additionally, and/or alternatively, the blob-grounded text-to-video diffusion model may be model-agnostic and may include and/or be associated with a U-Net and/or a diffusion transformer.

### CLAIM OF PRIORITY

This application claims the benefit of U.S. Provisional Application No. 63/715,087 (Attorney Docket No. 515138) titled “Blobgen-Vid: Compositional Text-To-Video Generation With Blob Representations,” filed Nov. 1, 2024 and U.S. Provisional Application No. 63/742,553 (Attorney Docket No. 515220) titled “Blobgen-Vid: Compositional Text-To-Video Generation With Blob Representations,” filed Jan. 7, 2025, the entire contents of which are incorporated herein by reference.

### BACKGROUND

Conventional text-to-video generation models have enabled the generation of more realistic videos with high visual quality and intricate motions. However, despite their progress, these conventional text-to-video models struggle to follow complex prompts, where they often neglect key objects or confuse multiple objects as one concept. In addition, users cannot control semantic transitions or camera motions with merely text descriptions with these conventional models. Therefore, it remains an open challenge to enhance the compositionality and controllability of video generators with layout guidance in the diffusion process. To resolve these challenges, newer text-to-video models have been proposed that condition video diffusion models on visual layouts (e.g., bounding boxes that move across the frames of the videos). Compared to other modalities such as depth or semantic maps, bounding boxes may be easier to create and manipulate by users while providing coarse-grained information of local objects. However, two-dimensional (2D) bounding boxes lack perspective invariance (e.g., a three-dimensional (3D) counterpart of a 2D bounding box on an image is not a 3D bounding box and vice versa). Accordingly, there is a need for addressing these issues and/or other issues associated with the prior art.

### SUMMARY

Embodiments of the present disclosure relate to compositional text-to-video generation with dense blob video representations. For example, conventional video generation models may struggle to follow complex text prompts and synthesize multiple objects, raising the need for additional grounding input for improved controllability. As such, embodiments of the present disclosure describe decomposing videos into visual primitives. For instance, embodiments of the present disclosure introduce blob video representations that serve as grounding conditions for generating videos using text-to-video diffusion models (e.g., a blob-grounded text-to-video diffusion model). For example, each blob video representation may correspond to an object instance and may be automatically extracted from videos (and/or three-dimensional (3D) scenes), making it a more general and robust representation for different visual domains. Specifically, a blob video representation may have two components-blob video parameters and blob video descriptions. The blob video representation may assist in enabling both motion and semantic control of visual compositions.

To put it another way and as will be described in further detail below, during training, embodiments of the present disclosure may decompose videos into visual primitives such as blob video representations, which may be general representations for controllable video generation. Based on the blob video representations (e.g., the blob video parameters and descriptions), a blob-grounded text-to-video diffusion model may be developed. In some examples, the blob-grounded text-to-video diffusion model may permit users to control object motions and fine-grained object appearance. Additionally, and/or alternatively, the blob-grounded text-to-video diffusion model may include a masked 3D attention module (e.g., masked 3D self-attention layers and/or masked spatial cross-attention layers) that effectively improves regional consistency across frames. Additionally, and/or alternatively, embodiments of the present disclosure may utilize context interpolation (e.g., a context interpolation block) that may interpolate text embeddings such that users may control semantics in specific frames and obtain smooth object transitions. Additionally, and/or alternatively, the blob-grounded text-to-video diffusion model may be model-agnostic. For instance, the blob-grounded text-to-video diffusion model may include a backbone that is and/or includes a U-Net and/or a diffusion transformer (DiT). After conducting extensive experimental results, it was shown that the blob-grounded text-to-video diffusion model described by embodiments of the present disclosure achieves superior zero-shot video generation ability and state-of-the-art layout controllability on multiple benchmarks. Furthermore, when combined with a large language model (LLM) for layout planning, it was shown that the blob-grounded text-to-video diffusion model even outperforms proprietary text-to-video generators in terms of compositional accuracy.

In an embodiment, a computer-implemented method for using a blob-grounded text-to-video diffusion model to generate an output video is provided. The method includes obtaining a blob video representation for an object to be generated within the output video. The blob video representation comprises a plurality of blob video parameters and a plurality of blob video descriptions. Each of the plurality of blob video parameters indicates a plurality of variables that define an ellipse for the object and each of the plurality of blob video descriptions indicates a textual description of the object. The method further includes processing the blob video representation using the blob-grounded text-to-video diffusion model to generate the output video. The blob-grounded text-to-video diffusion model comprises one or more blob-grounded attention layers that uses the blob video representation for the object as a grounding input to generate the output video.

### BRIEF DESCRIPTION OF THE DRAWINGS

The present systems and methods for compositional text-to-video generation with dense blob video representations are described in detail below with reference to the attached drawing figures, wherein:

FIG. 1A shows an image of a scene and a decomposition of the scene into blob representations, in accordance with one or more embodiments of the present disclosure.

FIG. 1B illustrates a block diagram of a general overview for generating dense blob representations and using the generated dense blob representations to train a blob-grounded text-to-image diffusion model, in accordance with one or more embodiments of the present disclosure.

FIG. 1C illustrates a block diagram showing a training process for training the blob-grounded text-to-image diffusion model, in accordance with one or more embodiments of the present disclosure.

FIG. 1D illustrates a block diagram showing interactions between a blob-grounded attention layer, blob representations, and a U-Net layer from a blob-grounded U-Net, in accordance with one or more embodiments of the present disclosure.

FIG. 2A illustrates a block diagram showing an inference phase that uses a trained blob-grounded text-to-image diffusion model to generate output images, in accordance with one or more embodiments of the present disclosure.

FIG. 2B shows a system prompt that is used to generate the blob parameters, in accordance with one or more embodiments of the present disclosure.

FIG. 2C shows a system prompt that is used to generate the blob descriptions, in accordance with one or more embodiments of the present disclosure.

FIG. 3 illustrates a flowchart of a method for using the blob-grounded text-to-image diffusion model to generate output images, in accordance with an embodiment.

FIG. 4 is a conceptual diagram of a processing system implemented using a parallel processing unit (PPU), suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

FIG. 7A illustrates a block diagram of a general overview for generating blob video representations and using the generated blob video representations to train a blob-grounded text-to-video diffusion model, in accordance with one or more embodiments of the present disclosure.

FIG. 7B shows a portion of a training process of the general overview of FIG. 7A, in accordance with one or more embodiments of the present disclosure.

FIG. 7C shows exemplary layers of a blob-grounded backbone of the blob-grounded text-to-video diffusion model, in accordance with one or more embodiments of the present disclosure.

FIG. 7D shows exemplary layers of another blob-grounded backbone of the blob-grounded text-to-video diffusion model, in accordance with one or more embodiments of the present disclosure.

FIG. 8 illustrates a block diagram showing an inference phase of using the trained blob-grounded text-to-video diffusion model to generate an output video, in accordance with one or more embodiments of the present disclosure.

FIG. 9 illustrates a flowchart of a method for using a blob-grounded text-to-video diffusion model to generate an output video, in accordance with an embodiment.

### DETAILED DESCRIPTION

Embodiments of the present disclosure may describe and use a new type of visual layout, termed dense blob representations or blob representations, to serve as grounding inputs to guide text-to-image generation. The blob representations correspond to visual primitives (e.g., objects in a scene) and may be automatically extracted from a scene.

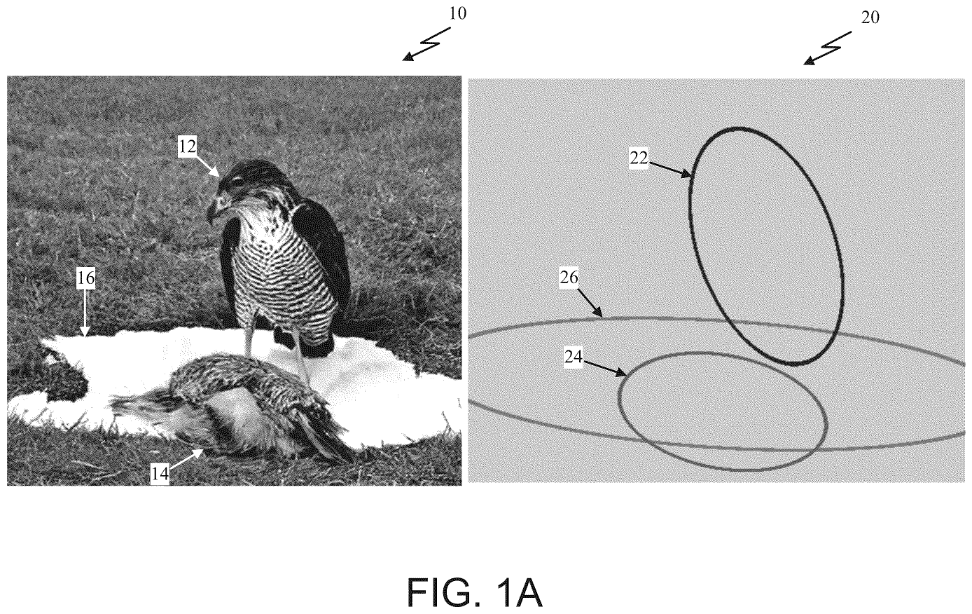

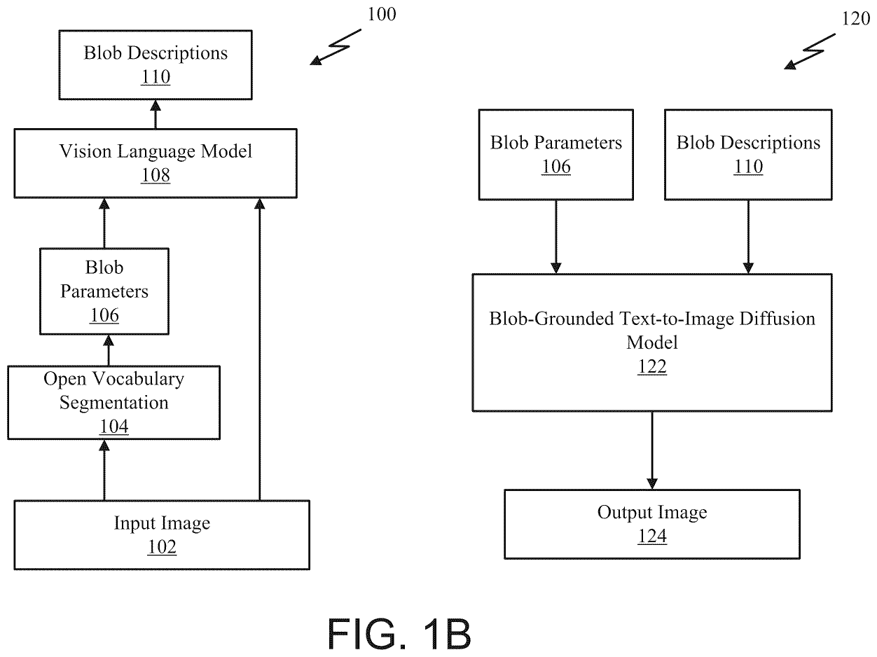

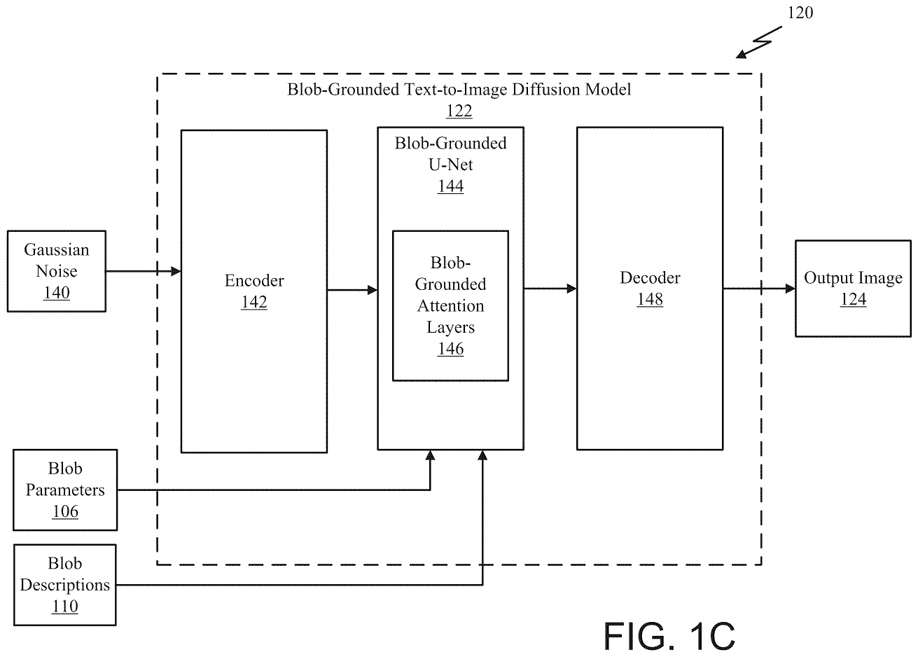

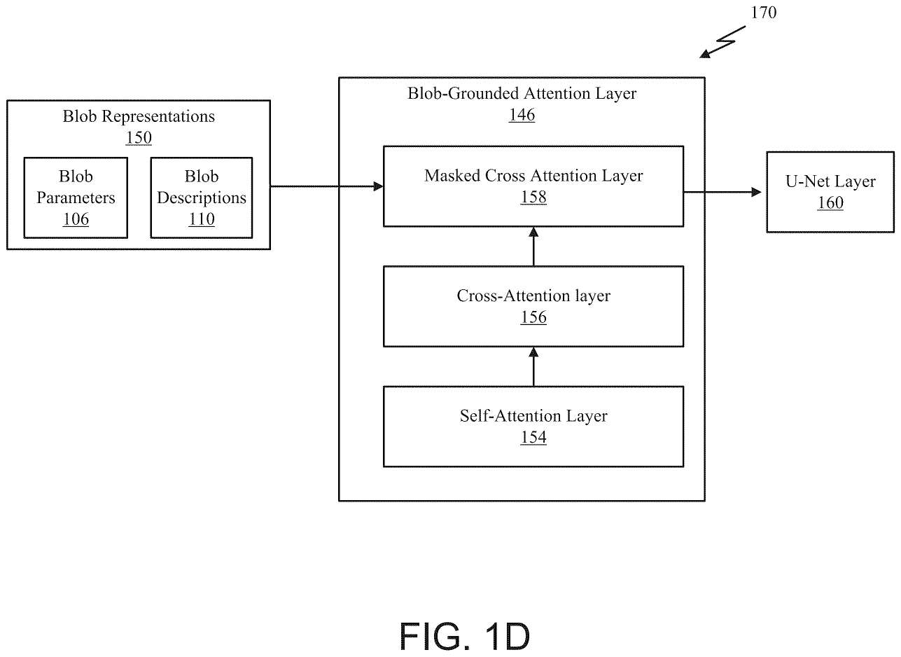

FIG. 1A shows an image of a scene 10 and a decomposition of the scene 20 into blob representations, in accordance with one or more embodiments of the present disclosure. For example, the image of the scene 10 may include objects such as two birds 12 and 14 as well as a patch of snow 16. Using one or more embodiments of the present disclosure, the image of the scene 10 may be decomposed into a decomposition of the scene 20, which includes blob representations 22, 24, and 26. For example, the object 12 (e.g., a first bird) may be decomposed into the blob representation 22, the object 14 (e.g., the second bird, which appears to lying on the ground) may be decomposed into the blob representation 24, and the object 16 (e.g., the patch of snow) may be decomposed into the blob representation 26. The decomposition of the objects 12-16 into the blob representations 22-26 will be described in further detail in FIG. 1B.

For example, a blob representation may include two components: 1) the blob parameter, which formulates a tilted ellipse to specify the object's position, size and orientation; and 2) the blob description, which is a rich text sentence that describes the object's appearance, style, and visual attributes. Referring to FIG. 1A, the blob representations 22-26 may represent one of the components of the blob representation—the blob parameter, which is shown as a tilted ellipse. The blob representation may largely preserve the fine-grained layout and semantic information of a scene (e.g., the image of the scene 10). Furthermore, since blob parameters and descriptions are both represented with structured texts, they may be easily constructed and manipulated by users.

As will be described below, embodiments of the present disclosure may develop (e.g., train) a blob-grounded text-to-image diffusion model, termed BlobGEN, that is built upon existing diffusion models and that uses blob representations (e.g., blob representations 22-26) as grounding inputs.

To disentangle the fusion between blob representations and visual features, a masked cross-attention module may be used that relates each blob to the corresponding visual feature solely in its local region. Furthermore, in some embodiments, a new in-context learning approach for LLMs is designed to generate dense blob representations from text prompts. By augmenting the blob-grounded text-to-image diffusion model with LLMs, embodiments of the present disclosure may leverage the visual understanding and compositional reasoning capabilities of LLMs to solve complex compositional image generation tasks. The blob-grounded text-to-image diffusion model may pave the way for a modular framework where images may be easily generated or manipulated by users and LLMs

The blob-grounded text-to-image diffusion model (e.g., BlobGEN) was tested extensively and was shown to achieve superior zero-shot generation quality and better layout guided controllability on MICROSOFT Common Objects in Context (MS-COCO). For instance, BlobGEN improves the zero-shot FID of base model from 10.40 to 8.61, and offers much better layout-guided controllability than conventional models as demonstrated by region-level Contrastive Language-Image Pretraining (CLIP) scores. By solely modifying a single blob representation while holding other blobs static, BlobGEN exhibits a strong local editing and object repositioning capability. With LLM augmentation, embodiments of the present disclosure were shown to excel in compositional generation tasks. For instance, using LLMs, embodiments of the present disclosure exhibit superior numerical and spatial correctness on compositional image generation benchmarks. Specifically, embodiments of the present disclosure were shown to outperform a conventional model by 5.7% and 1.4% for spatial and numerical accuracy on Numerical and Spatial Reasoning (NSR-1K) benchmarks.

As will be described in more detail below, embodiments of the present disclosure may decompose a scene into dense blob representations, each of which represents fine-grained details of a visual primitive in the scene. Additionally, and/or alternatively, embodiments of the present disclosure may further use BlobGEN, a blob-grounded modular text-to-image model with a new masked cross-attention module that takes blob representations as grounding inputs. Additionally, and/or alternatively, embodiments of the present disclosure may further augment BlobGEN with LLMs for compositional generation, by designing a new in-context learning approach for LLMs to infer blob representations from text prompts. Furthermore, as mentioned above, embodiments of the present disclosure were shown to achieve better zero-shot generation performance on MS-COCO, and have better numerical and spatial correctness in compositional benchmarks.

Initially, the image decomposition into blob representations will be first described below, and then the new generative framework that conditions on blob representations to generate images will be described. Further, the customized in-context learning procedure that prompts LLMs to generate blobs will be presented.

FIG. 1B illustrates a block diagram of a general overview for generating dense blob representations and using the generated dense blob representations to train a blob-grounded text-to-image diffusion model 122, in accordance with one or more embodiments of the present disclosure. The general overview includes a process 100 for generating the blob representations and a process 120 of using the generated dense blob representations to train a blob-grounded text-to-image diffusion model 122. For instance, based on an input image 102, the process 100 includes using an open vocabulary segmentation 104 and vision language model 108 to generate the blob representations including the blob parameters 106 and the blob descriptions 110. Then, using the blob parameters 106 and the blob descriptions 110, the process 120 includes using the blob-grounded text-to-image diffusion model 122 to generate an output image 124.

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the open vocabulary segmentation 104, the vision language model 108, and the blob-grounded text-to-image diffusion model 122 is within the scope and spirit of embodiments of the present disclosure.

For example, process 100 may be used for generating the blob representations, which may satisfy two properties: 1) they include fine-grained details of the scene such that the original image can be semantically reconstructed, and 2) they are modular, human-interpretable and easy to construct or manipulate (e.g., users can create and edit an image efficiently). The blob representations include two components—the blob parameters 106 and the blob descriptions 110. The blob parameters 106 may specify a size, location, and orientation of the blob using a vector of five variables [cₓ, c_{y}, a, b, θ], where (cₓ, c_{y}) is the center point of the ellipse, a and b are the radii of its semi-major and semi-minor axes, and θ∈(−π, π] is the orientation angle of the ellipse. In other words, the blob parameters 106 may represent the location and size of the object, and by including the orientation angle of the ellipse, the blob parameters 106 may additionally describe the orientation and pose of an object as well as more precisely describe the shape and size of the object. The blob descriptions 110 are text sentences that describe the visual appearance of an object, which complement the spatial layout information depicted by the blob parameter. For instance, the blob descriptions 110 may indicate objects within the input image 102 such as a mountain or a horse, and text sentences for the indicated objects such as “the horse is brown, on the right side of the image, and next to a picketed fence.”

To extract the blob parameters 106 from the input image 102, the input image 102 may be provided to an open vocabulary segmentation model 104. In some embodiments, the open vocabulary segmentation model 104 may include a standard segmentation model and an ellipse fitting optimization algorithm. In an embodiment, the standard segmentation model may be an open-vocabulary diffusion-based panoptic segmentation (ODISE) model, which is described in Xu et al., “Open-Vocabulary Panoptic Segmentation with Text-to-Image Diffusion Models” in Proceedings of the IEEE/CVF Conference on Computer Vision and Pattern Recognition, pp. 2955-2966 (2023) and is incorporated herein by reference. The input image 102 may be input into the standard segmentation model to generate instance segmentation maps, and the ellipse fitting optimization algorithm may use the instance segmentation maps to generate the blob parameters 106.

Following, the generated blob parameters 106 and the input image 102 may be used by the vision language model 108 to generate the blob descriptions 110. In some embodiments, the vision language model 108 may be a standard vision language model such as a Large Language and Vision Assistance (LLaVA), which is described in Liu et al., “Improved Baselines with Visual Instruction Tuning,” arXiv: 2310.03744 (2023) and is incorporated herein by reference. For instance, as mentioned above, the blob parameters 106 may be determined based on the instance segmentation maps that are generated using a standard segmentation model (e.g., the ODISE model). Then, minimal bounding boxes that contain the blob ellipses indicated by the blob parameters 106 may be determined, and the minimal bounding boxes may be used to crop the image 102. The cropped images may be fed to the vision language model 108 (e.g., LLaVA) to generate the blob descriptions 110 (e.g., captions for each of the blobs).

As such, referring back to FIG. 1A, based on an input image 102 (e.g., the image of the scene 10 shown in FIG. 1A), process 100 may be used to decompose the input image 102 into blob representations. For example, the open vocabulary segmentation 104 may be used to determine the blob parameters 22-24 for each of the objects 12-16 from the image of the scene 10. Furthermore, the vision language model 108 may be used to generate blob descriptions 110 for each of the objects 12-16.

In other words, for image decomposition into blob representations, given an image (e.g., input image 102), embodiments of the present disclosure aim to extract visual primitives or object-level representations that satisfy two properties: 1) they include fine-grained details of the scene such that the original image may be semantically reconstructed in the maximum degree from them, and 2) they are modular, human-interpretable and easy to construct or manipulate, which means users may create and edit an image efficiently. To this end, a new type of visual layouts (e.g., dense blob representations) is described herein, and each blob representation may describe a single object in a scene. A blob representation may include two components: a blob parameter (e.g., blob parameters 106) and a blob description (e.g., blob descriptions 110).

For example, a blob parameter 106 specifies the size, location, and orientation of the blob (e.g., object from the image such as object 12 from the image 10) using the vector of five variables. Intuitively, similar to the functionality of bounding boxes, the blob parameter 106 may represent the location and size of an object. For example, referring to FIG. 1A, the blob parameter 22 may represent the location and size of the object 12.

On the other hand, due to the existence of the orientation angle θ, the visual layout depicted by a blob parameter 106 is more fine-grained than a bounding box: 1) the blob parameter 106 may additionally describe the orientation or pose of an object, and 2) the blob parameter 106 may more precisely describe the shape and size of an object, particularly those with an elongated shape and a large inclined angle.

A blob description 110 is a text sentence that describes the visual appearance of an object, complementing the spatial layout information depicted by the blob parameter 106. In some embodiments, a region-level synthetic caption extracted by a pre-trained image captioner (e.g., the vision language model 108) may be used as the blob description 110. In some embodiments, the blob description 110 might not only provide the category name, but also may capture the detailed visual features of an object, including the object's appearance (e.g., color, texture, material, and so on) and the spatial relationship of sub-parts within the object region (e.g., “a wooden chair with brown legs and soft seat”). For example, the input image 102 may be an image of chairs around a table. The blob parameters 106 may indicate positions, orientation, shape, size, and/or other details regarding the objects (e.g., the chairs and table). Each blob description 110 may indicate a category name (e.g., chair or table) associated with a blob parameter 106, and may further indicate additional details such as the color, texture, material, and/or spatial relationships of sub-parts of the object or spatial relationships between the object and other objects within the image 102 (e.g., “the chair is next to the table”).

Since the blob representations retain the fine-grained visual layouts and other detailed visual features of the original image 102, a diffusion model (e.g., the blob-grounded text-to-image diffusion model 122) may be able to faithfully recover the input image 102. Moreover, both blob parameters 106 and descriptions 110 are in the form of simple text inputs, and thus the blob parameters 106 and descriptions 110 may be easily constructed and manipulated by human users and even generated by LLMs, which is described in further detail below.

After generating the blob representations from the input image 102, process 120 is performed to train the blob-grounded text-to-image diffusion model 122. For instance, the blob-grounded text-to-image diffusion model 122 may be a modified diffusion model that generates the output image 124 using the blob parameters 106 and the blob descriptions 110. In other words, the blob parameters 106 and the blob descriptions 110 may be utilized by the blob-grounded text-to-image diffusion model 122 as grounding inputs to guide the generation process for generating the output image 124. A standard diffusion model loss may be determined based on comparing the output image 124 to the input image 102, and the loss may be used to train the blob-grounded text-to-image diffusion model 122. The architecture and training for the blob-grounded text-to-image diffusion model 122 will be described in further detail in FIG. 1C.

FIG. 1C illustrates a block diagram showing a training process 120 for training the blob-grounded text-to-image diffusion model 122, in accordance with one or more embodiments of the present disclosure. For instance, FIG. 1C shows a more detailed version of the training process 120 shown in FIG. 1B.

In an embodiment, the blob-grounded text-to-image diffusion model 122 may be a modification of a pre-trained text-to-image stable diffusion model such as the pre-trained text-to-image stable diffusion model described in Rombach et al., “High-resolution image synthesis with latent diffusion models” in Proceedings of the IEEE/CVF conference on computer vision and pattern recognition, pp. 10684-10695 (2022) and incorporated herein by reference. In particular, a stable diffusion model may be a diffusion model that includes an encoder and a decoder with a U-Net in-between the encoder and decoder. In the blob-grounded text-to-image diffusion model 122, the encoder 142 and the decoder 148 might not be modified from the standard stable diffusion model (e.g., the stable diffusion model described in Rombach et al.), but the U-Net 144 (e.g., the blob-grounded U-Net 144) may be modified to include one or more blob-grounded attention layers 146. The blob-grounded attention layers 146 may be provided the blob parameters 106 and the blob descriptions 110 as grounding input for the image generation. In operation, the Gaussian noise 140 may be provided to the encoder 142, and the encoder output is provided to the blob-grounded U-Net 144. Functionally, the blob-grounded U-Net 144 may be similar to a standard U-Net from the stable diffusion model except that it utilizes the blob parameters 106 and the blob descriptions 110. Then, the U-Net output is provided to the decoder 148, and the decoder 148 generates the output image 124 based on the U-Net output.

For example, existing text-to-image diffusion models often include convolutional and self-attention layers that operate on image features directly, and cross-attention layers that inject text conditioning into the network. BlobGEN (e.g., blob-grounded text-to-image diffusion model 122) may be built upon the pre-trained text-to-image Stable Diffusion model (e.g., the stable diffusion model described in Rombach et al.) except new cross-attention layers (e.g., the blob-grounded attention layers 146) may be introduced to incorporate blob grounding into the diffusion model 122. To retain the prior knowledge of pre-trained models for synthesizing high-quality images, embodiments of the present disclosure may freeze the weights from the pre-trained text-to-image Stable Diffusion model (e.g., the weights from the encoder 142, the decoder 148, and the blob-grounded U-Net except for the blob-grounded attention layers 146) and only train the newly added layers (e.g., the blob-grounded attention layers 146). Below, with reference to FIG. 1D, blob-grounded generation is described in further detail.

FIG. 1D illustrates a block diagram showing interactions between a blob-grounded attention layer 146, blob representations 150 (e.g., the blob parameters 106 and the blob descriptions 110), and a U-Net layer 160 from a blob-grounded U-Net 144 from FIG. 1C, in accordance with one or more embodiments of the present disclosure.

For example, in text-to-image generation, traditionally, attention layers such as a self-attention layer and a cross-attention layer may be utilized for image generation. For instance, a U-Net may include a plurality of U-Net layers and each U-Net layer may be connected to one or more attention layers. The attention layers may be provided text prompts and the output from the attention layers may be provided to the U-Net layer to guide the U-Net in generating an output that is converted by the decoder to the output image. In contrast, in addition to having a self-attention layer 154 and a cross-attention layer 156, embodiments of the present disclosure also include a masked cross attention layer 158 that guides the U-Net layer 160 in generation of the image using the blob representations 150, including the blob parameters 106 and the blob descriptions 110. In some embodiments, each U-Net layer from the blob-grounded U-Net 144 may include a blob-grounded attention layer 146 that comprises a masked cross attention layer 158. For example, the blob-grounded U-Net 144 may include a plurality of U-Net layers, and each U-Net layer may include a blob-grounded attention layer 146 that comprises a masked cross attention layer 158.

In some embodiments, prior to utilizing the blob representations 150, one or more encoders may be used to embed the blob parameters 106 and the blob descriptions 110. The encoders may be included within the masked cross attention layer 158 or may be separate from the masked cross attention layer 158. For the blob parameters 106, the encoder first encodes the orientation angle θ of the blob parameters 106 to the sine and cosine representation (sin θ, cos θ), and then obtains the blob parameter embedding based on performing a Fourier feature encoding. For the blob descriptions 110, a text encoder (e.g., a Contrastive Language-Image Pretraining (CLIP) text encoder) is used to obtain the blob sentence embeddings. Then, the blob sentence embeddings and the blob parameter embeddings are concatenated to generate a concatenated blob representation embedding using a multi-layer perception (MLP) layer.

In other words, the blob parameter 106 may be denoted as τ:=[cₓ, c_{y}, a, b, θ] and the blob description 110 may be denoted as s:=[s₁, . . . , s_{L}], where L is the text sentence length, s₁ is the first word in a sentence of the blob description 110, and s₂ is the last word in a sentence of the blob description 110. For blob parameter τ 106, first, embodiments of the present disclosure may encode orientation angle θ of the blob parameter 106 to the sine and cosine representation (sin θ, cos θ), and then obtain the blob parameter embedding e_{τ}=Fourier(\tilde{τ})∈ [symbol] ^{dτ}, where \tilde{τ}:=[cₓ, c_{y}, a, b, sin θ, cos θ] and Fourier(·) denotes the Fourier feature encoding, and dt represents the dimensions of the blob parameter embedding er. The parameters of the blob parameter 106 (e.g., cₓ, c_{y}, a, b, sin θ, cos θ) are described above. For the blob description 110, the CLIP text encoder f may be used to obtain the sentence embedding eₛ=f(s):=[eₛ₁, . . . , e_{sL}]∈ [symbol] ^{L×d}^{ₛ}, where eₛ₁ is an embedding for the first word in the sentence of the blob description 110 and e_{sL} is an embedding for the last word in the sentence of the blob description 110. In some embodiments, the sentence embedding eₛ may be an embedding for more than one sentence (e.g., a short paragraph). For instance, using the CLIP text encoder, an embedding may be obtained for multiple sentences (e.g., multiple sentences that in their aggregate may have less than 77 total words). Before passing the blob sentence embedding to the network (e.g., to the masked cross attention layer 158 if the encoders are separate from the masked cross attention layer 158 or to the next component of the masked cross attention layer 158 if the encoders are within the masked cross attention layer 158), the two embeddings e_{τ} and eₛ are first concatenated. Thus, the final blob embedding for the blob representation e_{b} 150 is given by:

$${e}_{b} = MLP ( [ {\tilde{e}}_{{s}_{1}} , ... , {\tilde{e}}_{{S}_{L}} ] ) ∈ {ℝ}^{L \times {d}_{b}}$$

where \tilde{e}ₛₗ:=[eₛₗ; e_{τ}]∈ [symbol] ^{d}^{ₛ}^{+d}^{ᵣ} for all l∈{1, . . . , L} with [·;·] denoting a concatenation along the feature dimension, and MLP(·) represents an MLP layer. For the concatenation eₛₗ:=[eₛₗ; e_{τ}], since eₛₗ is an embedding vector of dimension of dₛ and e_{τ} is an embedding vector of dimension of dᵣ, the concatenated vector \tilde{e}ₛₗ may have a dimension of dₛ+dᵣ. Also, MLP(·) is a multi-layer perceptron network that maps a tensor of size L×(dₛ+dᵣ) to a new tensor of size L×d_{b}.

Using the concatenated blob representations (e.g., the concatenated blob representation embeddings) and the output from the cross-attention layer 156, the masked cross attention layer 158 generates visual tokens that are provided to the U-Net layer 160 to guide in the generation of the output image 124. For instance, in standard cross-attention, every blob embedding may attend to every feature “pixel” (in the height (h)×width (w) plane) of the feature maps, which might not be desirable given that each blob embedding only convey information about the blob embedding's corresponding local region and the blob embedding's interaction with other regions may confuse the model. In contrast, the masked cross attention layer 158 utilizes an attention mask that masks the feature maps such that each blob embedding only attends to its local region. The attention mask may be obtained based on downsampling each blob's binary ellipse mask where the mask indicates a “1” if the pixel is within the blob's ellipse, and a “0” if the pixel is not within the blob's ellipse. Then, using the attention mask, the concatenated blob representations, and the output from the cross-attention layer 156, the visual tokens that are provided to the U-Net layer 160 may be generated. For example, similar to the standard cross-attention layer 156, a Query from a linear projection of visual features of an image may be obtained (e.g., from the output of the cross-attention layer 156), and a Key and a Value from two separate linear projections of blob embeddings (e.g., the blob representations 150) may be obtained. Then, assuming there are “N” blobs in the image (e.g., referring to FIG. 1A, “N” may be three blobs within the image 10 and associated with objects 12-16), the attention weight matrices (before Softmax) may be decomposed into “N” blob-specific attention weight matrices between the Query from visual features and each Key from an individual blob embedding from the blob representations 150. For each blob-specific attention weight matrix, where matrix's row dimension is h×w (height×width) and column dimension is L (text sentence length), the matrix's row may be set to negative infinity based on the attention mask at this pixel being “0”.

In other words, an image may include “N” blob embeddings, which may be denoted as

$${\{ {e}_{b}^{( n )} \}}_{n = 1}^{N} .$$

For example, the image 10 from FIG. 1A may include three blob embeddings

$${e}_{b}^{( 1 )} , {e}_{b}^{( 2 )} , and {e}_{b}^{( 3 )}$$

for the objects 12-16. Further, g∈ [symbol] ^{hw×d}^{_{g}} may be defined as the visual features of an image, where h and w represent the spatial size of the feature maps, and d_{g} denotes the feature dimension. If the query, key and value are denoted by

$$q := {gW}_{q} ∈ {ℝ}^{hw \times {d}_{g}} , {k}^{( n )} := {e}_{b}^{( n )} {W}_{k}^{( n )} ∈ {ℝ}^{L \times {d}_{g}} , and {v}^{( n )} := {e}_{b}^{( n )} {W}_{v}^{( n )} ∈ {ℝ}^{L \times {d}_{g}} ,$$

respectively, a standard cross-attention between visual features of an image g and the blob embeddings

$${\{ {e}_{b}^{( n )} \}}_{n = 1}^{N}$$

is

$$CA ( g , \{ {e}_{b}^{( i )} \} ) = σ ( \frac{{q [ {k}^{( 1 )} ; … ; {k}^{( N )} ]}^{T}}{\sqrt{{d}_{g}}} ) [ {v}^{( 1 )} ; … ; {v}^{( N )} ]$$

where [·;·] is a concatenation along the sequence dimension and σ(·) is the softmax function. In the above, W_{q}, Wₖ, and Wᵥ may be blob-specific attention weight matrics for the Query, Key, and Value. In the example from FIG. 1A, the standard cross-attention is shown below

$$CA ( g , \{ {e}_{b}^{( i )} \} ) = σ ( \frac{{q [ {k}^{( 1 )} ; {k}^{( 2 )} ; {k}^{( 3 )} ]}^{T}}{\sqrt{{d}_{g}}} ) [ {v}^{( 1 )} ; {v}^{( 2 )} ; {v}^{( 3 )} ]$$

where q is the image feature tensor by passing the image 10 to the network, k⁽¹⁾, k⁽²⁾, k⁽³⁾ are the keys that are associated with blobs 22, 24 and 26, and v⁽¹⁾, v⁽²⁾, v⁽³⁾ are the values that are associated with blobs 22, 24 and 26. Each key from a blob may freely interact with (or attend to) any part in the feature tensor through the tensor inner product within the Softmax function.

As shown above, in the standard cross-attention, every blob embedding attends to every feature “pixel” (in the h×w plane) of the feature maps. This is undesirable since each blob embedding only conveys information about its corresponding local region, and its interaction with other regions may confuse the diffusion model, leading to more text leakage and entanglement in generation.

To resolve this, embodiments of the present disclosure may use a masked cross attention layer 158 to mask the feature maps g such that each blob embedding only attends to its local region. For example, denote the attention mask for the i-th blob as m⁽ⁱ⁾∈ [symbol] ^{hw}. The attention mask for the i-th blob may be obtained by downsampling the i-th blob's binary ellipse mask where a pixel value is “1” if it is within the blob ellipse, and “0” otherwise. For instance, the attention mask for the object 12 may be and/or include a one dimensional matrix of size h multiplied by w (e.g., each pixel within the image 10 may be associated with an entry within the attention mask matrix). Then, based on downsampling, for pixel values that are within the blob ellipse of the object 12 (e.g., within the blob ellipse shown by the blob parameter 22), the attention mask for the object 12 would include a pixel value of “1”. Otherwise, the attention mask for the object 12 would include a pixel value of “0”.

Accordingly, the masked cross-attention used by the masked cross attention layer 158 may be defined as

$${CA}_{m} ( g , \{ {e}_{b}^{( i )} , {m}^{( i )} \} ) = σ ( \frac{[ {a}^{( 1 )} ; … ; {a}^{( N )} ]}{\sqrt{{d}_{g}}} ) [ {v}^{( 1 )} ; … ; {v}^{( N )} ]$$

where the i^{th} attention weight for the j^{th} location is:

$${a}_{j}^{( i )} = \{ \begin{matrix}{q}_{j} {k}^{( i ) T} & if {m}_{j}^{( i )} = 1 \\ - ∞ & otherwise\end{matrix} for j ∈ \{ 1 , 2 , ... , hw \} .$$

Thus, for image 10, the masked cross-attention is

$${CA}_{m} ( g , \{ {e}_{b}^{( i )} , {m}^{( i )} \} ) = σ ( \frac{[ {a}^{( 1 )} ; {a}^{( 2 )} ; {a}^{( 3 )} ]}{\sqrt{{d}_{g}}} ) [ {v}^{( 1 )} ; {v}^{( 2 )} ; {v}^{( 3 )} ]$$

and the difference between the masked cross-attention and the standard cross-attention is within the numerator of the softmax function (e.g., the Key and Query), which utilizes the attention mask that is described above. For example, for the object 12, which is associated with the blob parameter 22, the attention weight matrix

$${a}_{j}^{( 1 )}$$

may be represented as

$${a}_{j}^{( 1 )} = \{ \begin{matrix}{q}_{j} {k}^{( 1 ) T} if {m}_{j}^{( 1 )} = 1 & for j ∈ \{ 1 , 2 , … , hw \} \\ - ∞ & otherwise\end{matrix} .$$

where a standard attention weight is obtained based on the attention mask indicating a pixel value of “1” for the pixel (e.g., the pixel is within the ellipse of the blob parameter 22), but the attention weight is set to negative infinity based on the attention mask indicating a pixel value of “0” for the pixel (e.g., the pixel is outside the ellipse of the blob parameter 22). Thus, for the example from FIG. 1A, using the attention mask, the blob parameters 22 and 26 may both attend to pixels that are within the overlapping region (e.g., the region where blob parameters 22 and 26 overlap each other). Further, outside of the overlapping region, the blob parameters 22 and 26 may further attend to their own regions (e.g., the region within the blob parameter 22 that is not overlapping with the blob parameter 26). Additionally, the blob parameters 22 and 26 might not attend to other regions within the image 10 such as the region that is within blob parameter 24, but not within blob parameter 26.

With this masking design, blob representations and local visual features are well aligned in an explicit manner. Therefore, the blob grounding process may be more modular and independent across different object regions, and the blob-grounded text-to-image diffusion model 122 may be more disentangled in generation.

In some embodiments, for the training process 120, the blob-grounded text-to-image diffusion model 122 may begin as a pre-trained stable diffusion model. Then, the weights of the pre-trained stable diffusion model may be frozen, and only the newly added layers (e.g., the masked cross attention layer 158) may be trained. Thus, the stable diffusion loss may be determined based on comparing the output image 124 and the input image 102, and the stable diffusion loss may be used to train only the weights from the masked cross attention layers 158.

In some embodiments, the masked cross-attention module (e.g., the blob-grounded attention layer 146 and/or the masked cross attention layer 158) may be added in a gated way, where a learnable scalar controls the information flow from the cross-attention branch (e.g., the cross-attention layer 156) for more stable training. In some embodiments, the gated self-attention module that is described in Li et al., “Open-set grounded text-to-image generation” in Proceedings of the IEEE/CVF Conference on Computer Vision and Pattern Recognition, pp. 22511-22521 (2023) and is incorporated herein by reference is also added, which shows a slight improvement in generation quality. In some embodiments, embodiments of the present disclosure might not make any changes to self-attention and convolutional layers (e.g., the self-attention layers 154), allowing information to propagate across different image regions for overall long-range correlations. For the image-level global captions, in some embodiments, synthetic image-level global captions may be used to train the blob-grounded text-to-image diffusion model 122 as global captions may work better than original real captions. In some embodiments, the original denoising score matching loss may be used to train only the new parameters (e.g., the weights from the masked cross attention layer 158). After training, the blob-grounded text-to-image diffusion model 122 may be used in the inference phase to generate images from the blob representations.

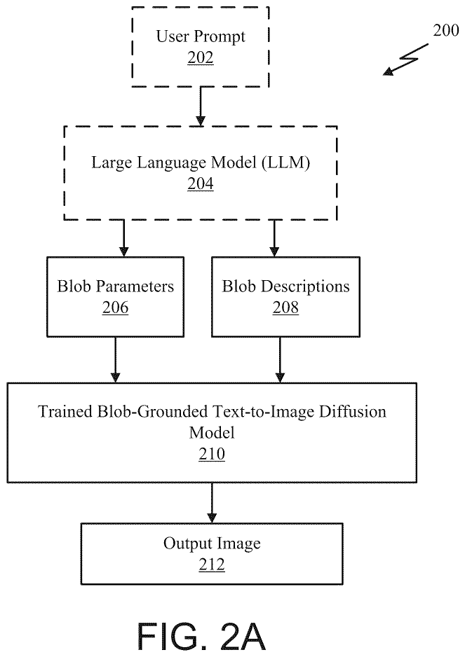

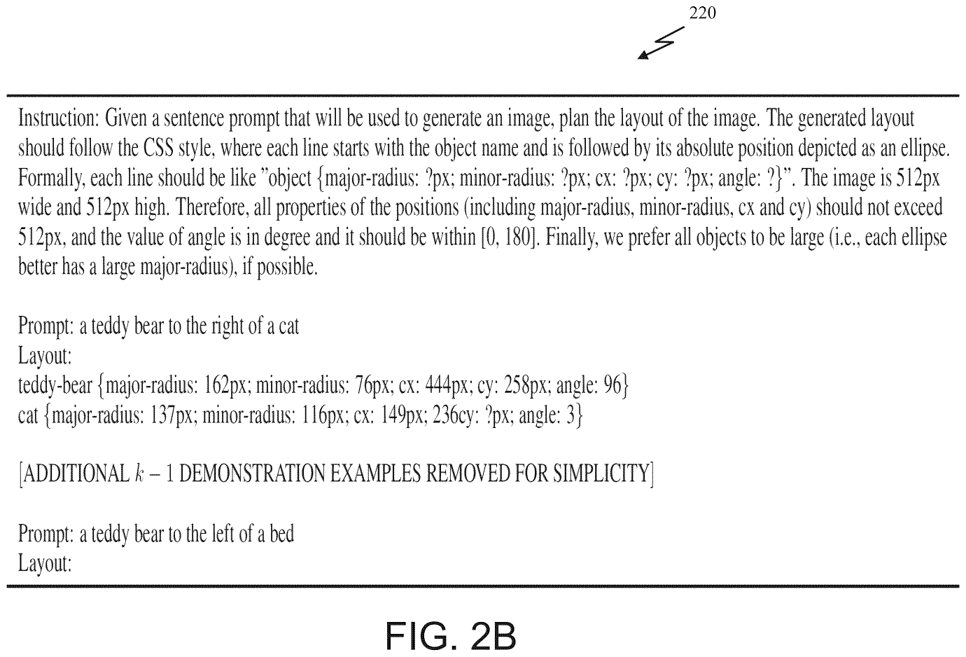

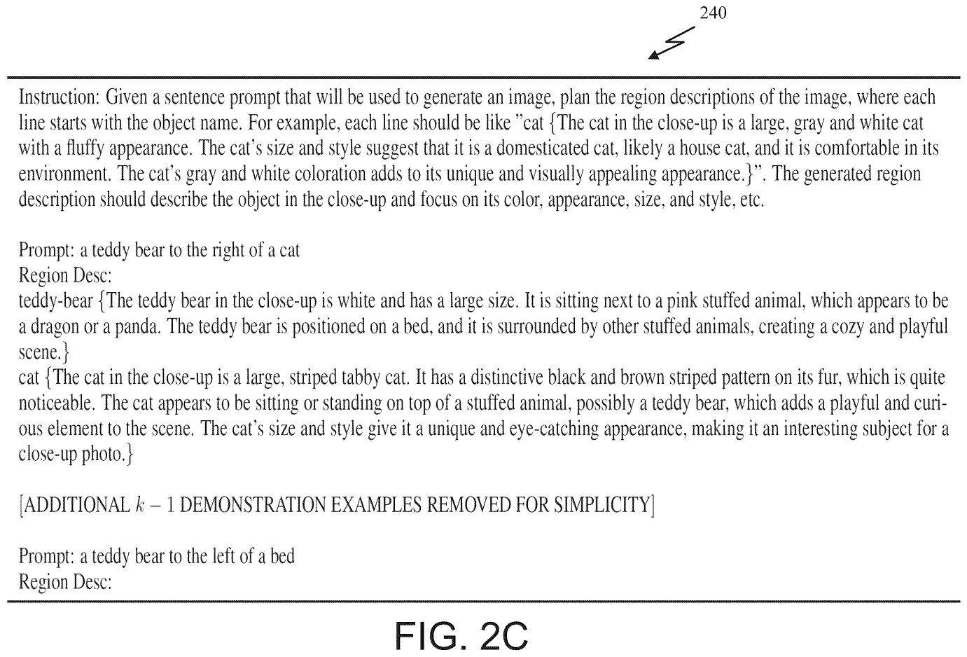

FIG. 2A illustrates a block diagram showing an inference phase 200 that uses a trained blob-grounded text-to-image diffusion model 210 to generate output images 212, in accordance with one or more embodiments of the present disclosure. The trained blob-grounded text-to-image diffusion model 210 may be the blob-grounded text-to-image diffusion model 122 after the blob-grounded text-to-image diffusion model 122 has been trained (e.g., based on using processes 100 and 120). As shown, the large language model (LLM) 204 and the user prompt 202 are denoted as dashed boxes to show that they are optional.

For example, in embodiments without the user prompt 202 and the LLM 204, a user may provide the blob parameters 206 and the blob descriptions 208 to the trained blob-grounded text-to-image diffusion model 210. Based on the inputs, the trained blob-grounded text-to-image diffusion model 210 generates the output image 212. Additionally, and/or alternatively, users may be able to manipulate either the blob parameters 206 and/or the blob descriptions 208 such as by adjusting one or more parameters from the blob parameters 206. Thus, based on manually adjusting the blob parameters 206 and/or the blob descriptions 208, the trained blob-grounded text-to-image diffusion model 210 may be able to account for the user manipulations and generate output images 212 that reflect the user manipulations. For instance, based on user input indicating to move the object from a person's right hand to left hand, the blob parameters 206 and/or the blob descriptions 208 may be obtained that indicate the user input. Then, the modified blob parameters 206 and/or the modified blob descriptions 208 may be utilized as grounding input for the trained blob-grounded text-to-image diffusion model 210, and the output image 212 may reflect the movement of the object from the person's right hand to left hand.

In some embodiments, the LLM 204 may be utilized to generate the blob parameters 206 and the blob descriptions 208 from the user prompt 202. Specifically, as described below, two separate in-context learned processes may be designed: one for generating blob parameters 206 and another for generating blob descriptions 208.

For instance, for generating the blob parameters 206, a compressed column storage (CCS) format may be adopted to represent blob parameters 206 such that LLMs 204 better understand their spatial meaning. Each generated layout in an in-context example starts with the category name, followed by a declaration section in the CSS style, which is “object {major-radius: ?px; minor-radius: ?px; cx: ?px; cy: ?px; angle: ? }”. The first four values are measured in pixel length, whereas the last value for angle is expressed in degree and normalized to be within [0, 180]. All values are rounded to integers. Next, top-k similar demonstration examples may be selected. The final prompt for LLMs 204 may include a system prompt that instructs the blob parameter generation, k demonstration examples, and the test prompt (e.g., a global caption).

In other words, initially, one or more system prompts may be generated (e.g., based on task design) and then provided to the LLM 204 to instruct the LLM 204 on how to generate the blob parameters 206 and the blob descriptions 208. The system prompt may indicate an instruction and demonstration examples. For instance, FIG. 2B shows a system prompt 220 that is used to generate the blob parameters 206, in accordance with one or more embodiments of the present disclosure. For instance, the system prompt 220 shows a set of instructions demonstration examples (e.g., prompt and layout), and a text prompt of a real example to show the system prompt 220 (e.g., “a teddy bear to the left of a bed”).

For example, for a system prompt to generate the blob parameters 206, the instruction set (e.g., the instructions shown in system prompt 220) may indicate that based on a sentence prompt that will be used to generate an image, the layout of the image may be planned. Specifically, the layout of the image may follow CCS style starting with an object name and followed by its position depicted as an ellipse (e.g., the five parameters of the blob parameters 206 described above). The system prompt (e.g., system prompt 220) may further include demonstration examples that may indicate example prompts as well as example layouts (e.g., examples of the five parameters for the blob parameters 206). After providing the system prompt (e.g., system prompt 220) to instruct the LLM 204, the LLM 204 may be provided a user prompt 202, and generate blob parameters 206 based on the user prompt 202.

Turning to the generation of blob descriptions 208, blob descriptions 208 may be less structured as they are essentially a list of text sentences. Thus, the CSS format might not be used to generate the blob descriptions 208, but the category name may still be used as a separator between blobs for the case of LLM generation. Thus, each generated blob description 208 in an in-context example is formatted as “object {text sentence}”. The same method to select top-k demonstration examples and construct the final prompt as described above for the blob parameters 206 may be used, which includes a system prompt that instructs the blob description generation, k demonstration examples, and the test prompt.

In other words, to generate the blob descriptions 208, another system prompt may be generated and provided to the LLM 204. FIG. 2C shows a system prompt 240 that is used to generate the blob descriptions 208, in accordance with one or more embodiments of the present disclosure. For instance, the system prompt 240 shows a set of instructions demonstration examples (e.g., prompt and layout), and a text prompt of a real example to show the system prompt 240 (e.g., “a teddy bear to the left of a bed”).

The system prompt for the blob descriptions 208 (e.g., the system prompt 240) does not use the CCS format, but instead uses the category name as a separator between blobs for the case of LLM generation. For instance, the instruction set for the blob descriptions 208 (e.g., the system prompt 240) may indicate that given a sentence prompt that will be used to generate an image, plan the region descriptions of the image where each line starts with the object name. Further, the system prompt (e.g., the system prompt 240) may include demonstration examples. After providing the system prompt (e.g., the system prompt 240) to instruct the LLM 204, the LLM 204 may be provided a user prompt 202, and generate blob descriptions 208 based on the user prompt 202.

In some examples, embodiments of the present disclosure may use image editing. For example, various image editing tasks (e.g., image editing on MS-COCO) may be performed by modifying the blob parameter for object repositioning, or modifying the blob description for local object/attribute manipulation. Thus, embodiments of the present disclosure may enable various image editing capabilities, including changing the fine-grained orientation of an object that conventional techniques might not be able to accomplish.

In some instances, embodiments of the present disclosure may use numerical and spatial reasoning. For example, embodiments of the present disclosure might not only generate images with better spatial and numerical correctness, but also may have better visual quality with less “copy-and-paste” effect.

Among other benefits and advantages, embodiments of the present disclosure provide a process 100 to decompose an input image 102 into blob parameters 106 to describe the location and size of objects within the image 102 and blob descriptions 110 to describe the visual appearance of the objects. Additionally, and/or alternatively, embodiments of the present disclosure train a blob-grounded text-to-image diffusion model 122 that comprises masked cross attention layers 158. Additionally, and/or alternatively, embodiments of the present disclosure use LLMs 204 to generate blob parameters 206 and blob descriptions 208 from user prompts 202, and then using the blob parameters 206 and blob descriptions 208 as well as a trained blob-grounded text-to-image diffusion model 210 to generate images 212.

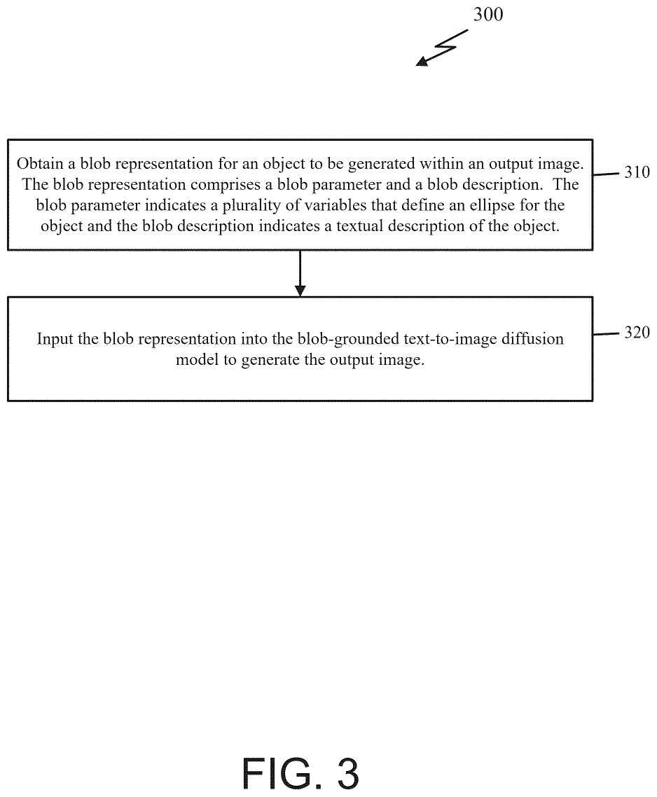

FIG. 3 illustrates a flowchart of a method 300 for using the blob-grounded text-to-image diffusion model to generate output images, in accordance with an embodiment. Each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the blob-grounded text-to-image diffusion model 122 of FIG. 1B and the trained blob-grounded text-to-image diffusion model 210 of FIG. 2A. However, the method 300 may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 310, a blob representation for an object to be generated within an output image is obtained. The blob representation comprises a blob parameter and a blob description. The blob parameter indicates a plurality of variables that define an ellipse for the object and the blob description indicates a textual description of the object. In an embodiment, the method 300 further comprises obtaining a request to generate the output image, wherein the request comprises a user prompt. And, obtaining the blob representation comprises: generating the blob parameter and the blob description based on inputting the user prompt into one or more large language models (LLMs).

In an embodiment, generating the blob parameter and the blob description based on inputting the user prompt into the one or more LLMs comprises: generating a first system prompt for the blob parameter using the user prompt; generating a second system prompt for the blob description using the user prompt; and providing the first system prompt and the second system prompt to the one or more LLMs to generate the blob parameter and the blob description.

At step 320, the blob representation is input into a blob-grounded text-to-image diffusion model (e.g., the trained blob-grounded text-to-image diffusion model 210) to generate the output image. In an embodiment, the blob-grounded text-to-image diffusion model (e.g., the trained blob-grounded text-to-image diffusion model 210) is a modified stable diffusion model that comprises an encoder (e.g., encoder 142), a decoder (e.g., decoder 148), and a blob-grounded U-Net architecture (e.g., the blob-grounded U-Net 144) and the blob-grounded U-Net architecture comprises blob-grounded attention layers (e.g., blob-grounded attention layers 146) and a plurality of U-Net layers.

In an embodiment, each of the blob-grounded attention layers (e.g., blob-grounded attention layers 146) comprise a masked cross attention layer (e.g., masked cross attention layer 158) that is connected to a U-Net layer (e.g., U-Net Layer 160) of the plurality of U-Net layers and inputting the blob representation into the blob-grounded text-to-image diffusion model to generate the output image comprises: generating visual tokens based on providing a blob representation embedding to the masked cross attention layer (e.g., masked cross attention layer 158); and providing the generated visual tokens to the U-Net layer (e.g., the U-Net layer 160) to guide the U-Net layer in generating the output image.

In an embodiment, inputting the blob representation into the blob-grounded text-to-image diffusion model to generate the output image further comprises: performing a Fourier feature encoding to encode the blob parameter into a blob parameter embedding; inputting the blob description into a text encoder to generate a blob sentence embedding; and concatenating the blob parameter embedding and the blob sentence embedding to generate the blob representation embedding.

In an embodiment, inputting the blob representation into the blob-grounded text-to-image diffusion model to generate the output image further comprises: generating an attention mask that attends to a subset of a plurality of pixels based on the subset of the plurality of pixels being within a blob ellipse that is defined by the blob parameter. Further, generating the visual tokens comprises generating, by the masked cross attention layer, the visual tokens based on the blob representation embedding attending to only the subset of the plurality of pixels that are within the blob ellipse being defined by the blob parameter.

In an embodiment, prior to performing steps 310 and 320, the method 300 further comprises training the blob-grounded text-to-image diffusion model using training data comprising a training image and one or more training models. In an embodiment, training the blob-grounded text-to-image diffusion model comprises: inputting the training image into an open vocabulary segmentation model to generate one or more training blob parameters; inputting the one or more training blob parameters and the training image into a vision language model to generate one or more training blob descriptions; inputting the one or more training blob parameters and the one or more training blob descriptions into the blob-grounded text-to-image diffusion model to generate a training output image; and training the blob-grounded text-to-image diffusion model based on comparing the training output image with the training image.

In an embodiment, the open vocabulary segmentation model is an open-vocabulary diffusion-based panoptic segmentation (ODISE) model and inputting the training image into the open vocabulary segmentation model to generate the one or more training blob parameters comprises: inputting an embedding of the input image into the ODISE model to generate instance segmentation maps; and using an ellipse fitting optimization algorithm to generate the one or more training blob parameters from the instance segmentation maps. In an embodiment, the vision language model is a Large Language and Vision Assistance (LLaVA) model and each of the one or more training blob descriptions comprises captions that describe a training blob parameter from the one or more training blob parameters.

In an embodiment, at least one of steps 310 and 320 and/or the further steps described above for method 300 are performed on a server or in a data center to train the blob-grounded text-to-image diffusion model 122 and/or use the trained grounded text-to-image diffusion model 210 to generate the output image, and the output image is streamed to a user device. In an embodiment, at least one of steps 310 and 320 and/or the further steps described above for method 300 is performed within a cloud computing environment. In an embodiment, at least one of steps 310 and 320 and/or the further steps described above for method 300 is performed for training, testing, or certifying a neural network employed in a machine, robot, or autonomous vehicle. In an embodiment, at least one of steps 310 and 320 and/or the further steps described above for method 300 is performed on a virtual machine comprising a portion of a graphics processing unit.

In some examples, because existing text-to-image models may struggle to follow complex text prompts, which raises the need for extra grounding inputs for better controllability, embodiments of the present disclosure may generate dense blob representations such as blob parameters and blob descriptions, and use the dense blob representations as grounding inputs to generate images. For instance, embodiments of the present disclosure may first train a blob-grounded text-to-image diffusion model that accepts the blob representations as grounding inputs, and then use the trained blob-grounded text-to-image diffusion model to generate images. In some variations, embodiments of the present disclosure may decompose a scene into visual primitives (e.g., dense blob representations) that include fine-grained details of the scene while being modular, human-interpretable, and easy-to-construct. Based on the blob representations, embodiments of the present disclosure may develop (e.g., train) a blob-grounded text-to-image diffusion model for compositional generation. For example, in some embodiments, a new masked cross-attention module may be introduced to disentangle the fusion between blob representations and visual features. In some embodiments, after training and during the inference phase, based on a user prompt, LLMs may be used to generate the blob representations. Subsequently, the generated blob representations may be fed into the trained blob-grounded text-to-image diffusion model to generate images responsive to the user prompt.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

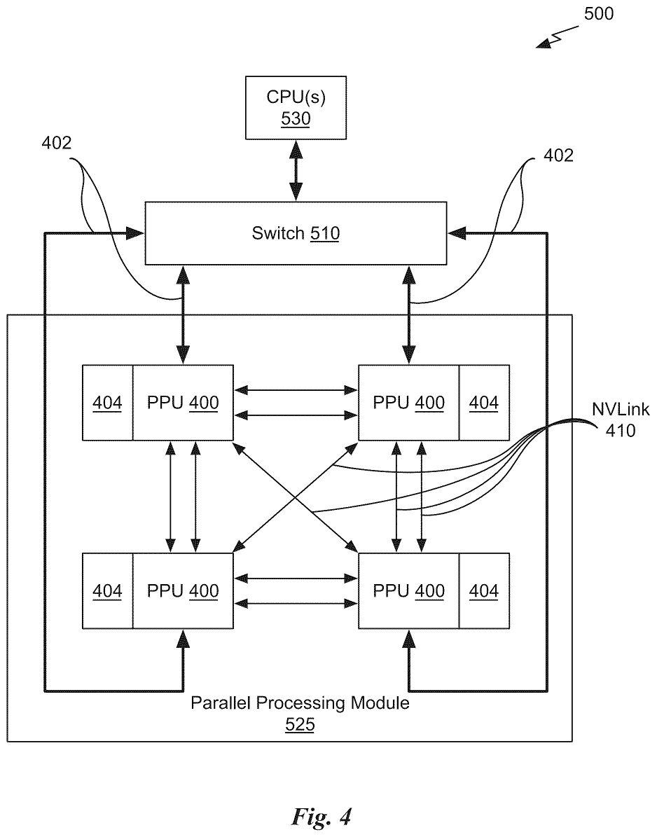

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

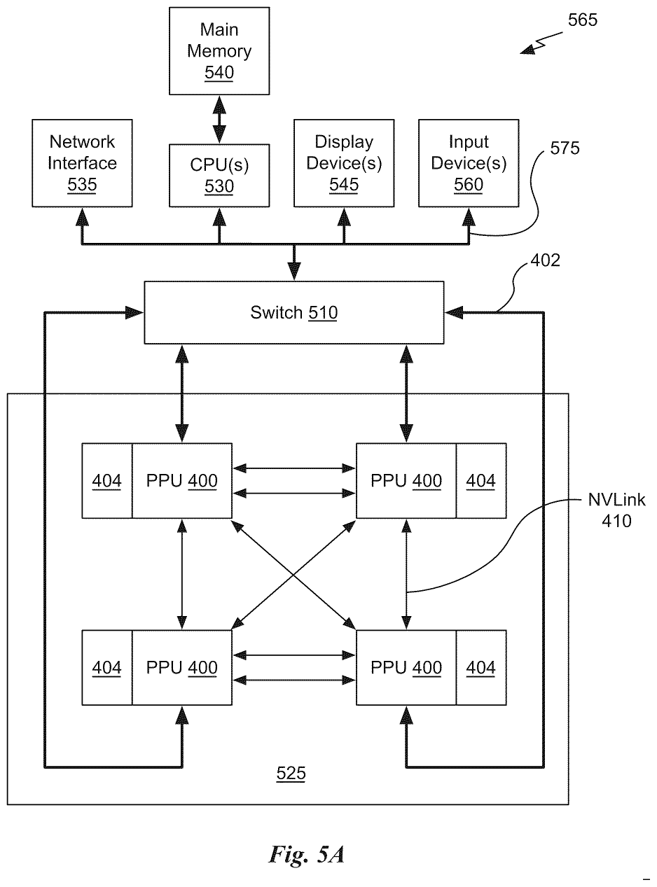

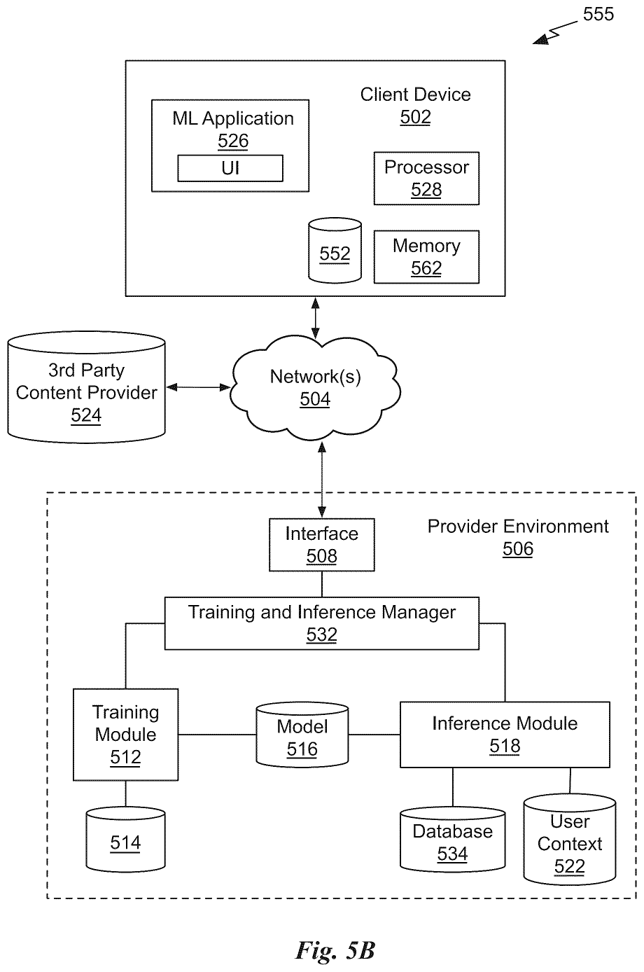

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

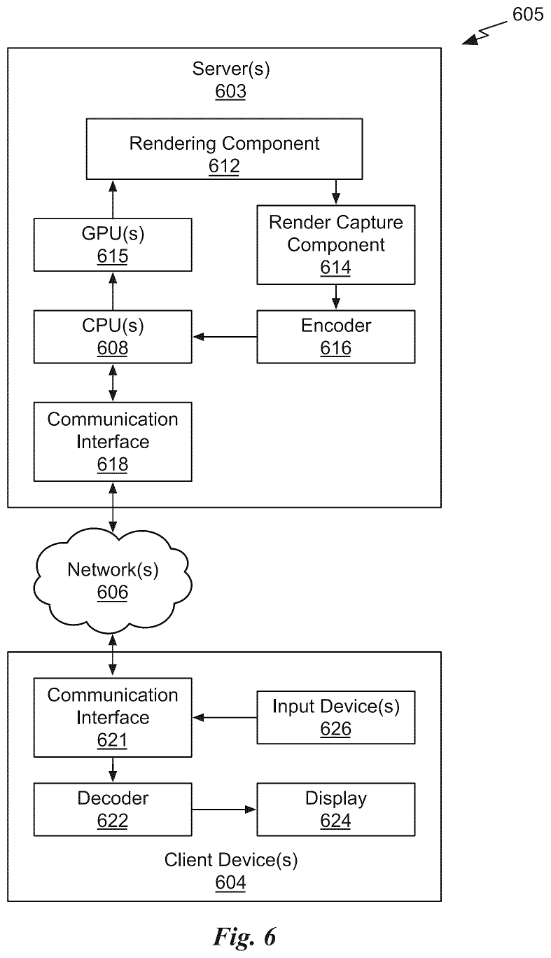

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

Below, a new type of visual layouts for video generation (e.g., blob video representations) that serve as grounding conditions is introduced. For example, each blob video representation may correspond to an object instance and may be automatically extracted from videos (or 3D scenes), making it a more general and robust representation for different visual domains. In some examples, a blob video representation may include two components: 1) the blob parameters, which formulate a tilted ellipse to specify the object's location, size, and orientation; and 2) the blob description, which is a free-form language description of the object's visual attributes. The blob parameters and the blob description may be similar to the blob parameters 106 and the blob descriptions 110 described above. By using the blob video representation, this enables both motion and semantic control of visual compositions, and it may further allow users to conveniently create and manipulate such representations as the blob parameters may be represented as structured text.

While layout conditions have been widely studied in image generation, directly applying these methods in video may lead to temporal inconsistency or compromised layout control. Conventional approaches have adapted these conditions for video generation with new techniques. However, these conventional approaches still suffer from the many issues and are limited to class conditions for each object box. To this end, embodiments of the present disclosure utilize a blob-grounded text-to-video diffusion framework (e.g., blob-grounded text-to-video diffusion model) that is built upon existing video diffusion models using blob representations as grounding input. In some examples, the blob-grounded text-to-video diffusion model may utilize a masked 3D attention module that facilitates object-centric spatial-temporal attention. Additionally, and/or alternatively, the blob-grounded text-to-video diffusion model may utilize masked cross-attentions to fuse free-form object descriptions into the blob regions. As some frames might not have blob captions, embodiments of the present disclosure may integrate a context interpolation module to enhance semantic transition throughout time.

In some instances, the blob-grounded text-to-video diffusion model may be a model-agnostic framework that may be applied to both UNet and DiT based diffusion models. It was shown through experiments in open-domain video generation that the blob-grounded text-to-video diffusion model outperforms existing layout-guided video generators by a large margin in multiple dimensions. For instance, the blob-grounded text-to-video diffusion model was evaluated on a wide range of benchmarks and it was shown that the blob-grounded text-to-video diffusion model improves the layout controllability by at least 20% in mean intersection over union (mIOU) and prompt alignment by 5% in contrastive language-image pretraining (CLIP) similarity. When combined with LLMs for blob planning, embodiments of the present disclosure out-perform proprietary video generators in multiple aspects. Furthermore, it was demonstrated that the blob-grounded text-to-video diffusion model also achieves improved consistency and camera control in multiview image generation in indoor scenes.

As will be described in further detail below, embodiments of the present disclosure utilize a new blob representation for text-to-video generation that enables fine-grained control of each object such as its motion and appearance. Furthermore, the blob-grounded text-to-video diffusion model may incorporate two types of masked attention modules and a context interpolation module to pre-trained video diffusion models for regional control and temporal consistency. In some examples, the blob-grounded text-to-video diffusion model may be applied to both UNet and DiT based diffusion backbones.

In the below, the extension of BlobGEN to video generation, including new blob video representations for the video data and new masked spatial cross-attention layers that fuse blob video representations to video diffusion networks, will be first described. Then, new masked 3D attention layers to improve temporal consistency in the object level is described in further detail. Following, blob video generation based on LLMs, which may serve as a stage before utilizing the blob-grounded text-to-video diffusion model to save human efforts from manually designing layouts, is described.

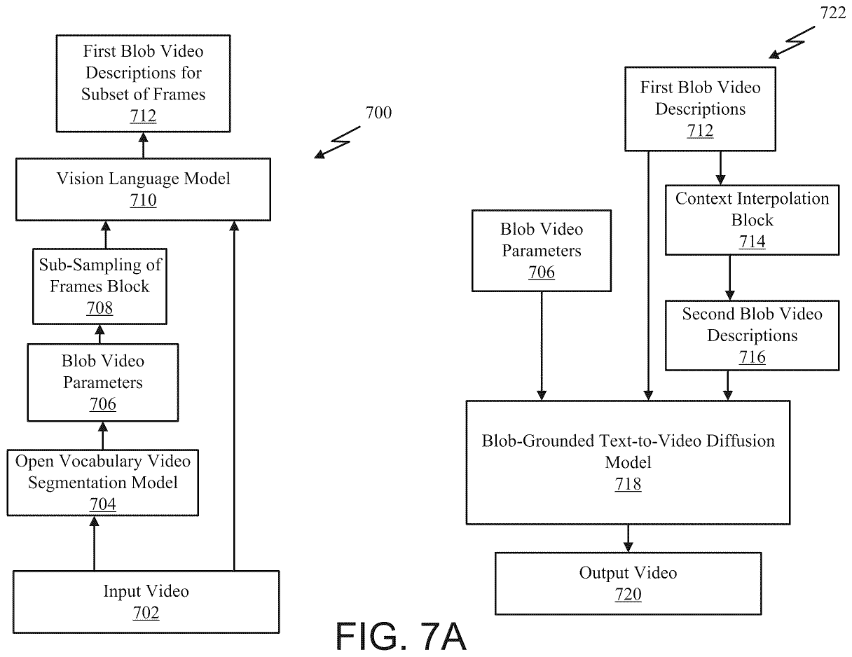

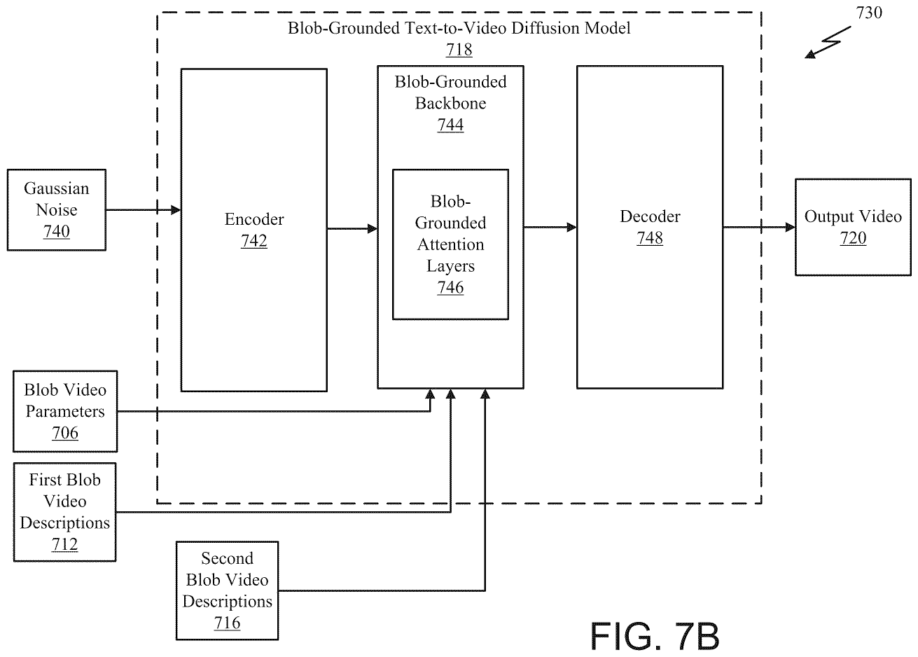

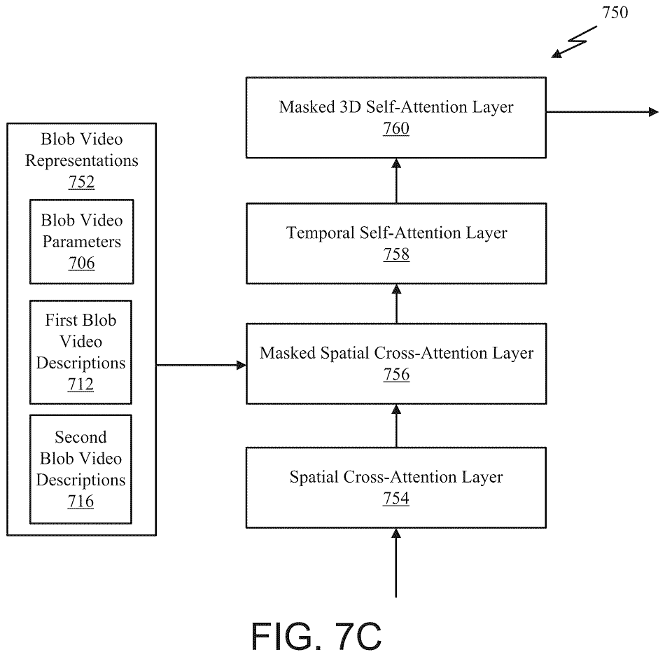

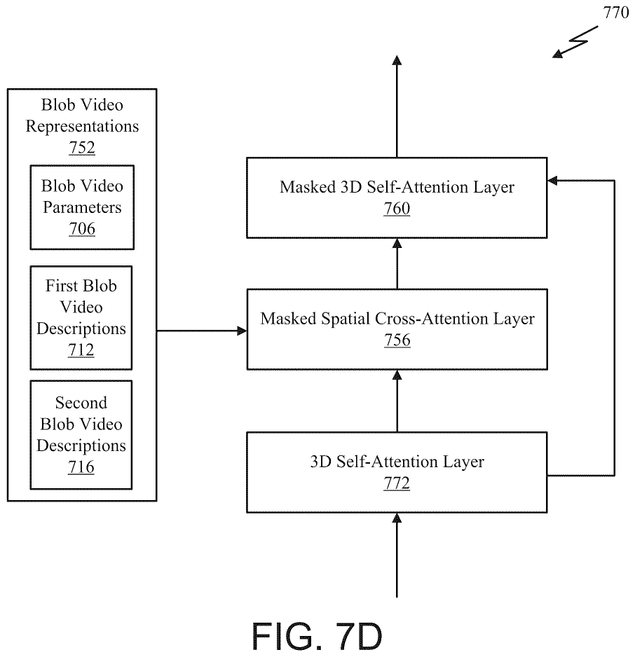

FIG. 7A illustrates a block diagram of a general overview for generating blob video representations (e.g., process 700) and using the generated blob video representations to train a blob-grounded text-to-video diffusion model 718 (e.g., process 722), in accordance with one or more embodiments of the present disclosure. For example, process 700 may be used for generating the blob video representations that include: 1) blob video parameters 706, which formulate a tilted ellipse to specify the object's location, size, and orientation within frames of the input video 702; and 2) blob video descriptions 712 and 716, which are free-form language descriptions of the object's visual attributes. Each of the blob video parameters 706 may specify a size, location, and orientation of a blob using a vector of five variables [cₓ, c_{y}, a, b, θ], where (cₓ, c_{y}) is the center point of the ellipse, a and b are the radii of its semi-major and semi-minor axes, and θ∈(−π, π] is the orientation angle of the ellipse. In other words, the blob video parameters 706 may represent the location and size of an object within a frame of the input video 702, and by including the orientation angle of the ellipse, the blob video parameters 706 may additionally describe the orientation and pose of an object as well as more precisely describe the shape and size of the object. The blob video descriptions 712 and 716 are text sentences that describe the visual appearance of an object, which complement the spatial layout information depicted by the blob video parameters 706. For instance, the blob video descriptions 712 and 716 may indicate objects within the input video 702 such as a mountain or a horse, and text sentences for the indicated objects such as “the horse is brown, on the right side of the image, and next to a picketed fence.”

To extract the blob video parameters 706 from the input video 702 (e.g., a training input video), the input video 702 may be provided to an open vocabulary video segmentation model 704. In some embodiments, the open vocabulary video segmentation model 704 may include one or more models such as a first model to obtain segmentation masks for the first frame and a second model to obtain the segmentation masks for the other frames of the input video 702. In an embodiment, the first model may be an open-vocabulary diffusion-based panoptic segmentation (ODISE) model and/or a Grounding Detection with Image and Text Network (Grounding Dino) model, which is described by Liu et al., “Grounding dino: Marrying dino with grounded pre-training for open-set object detection,” arXiv: 2303.05499 (2023) and is incorporated by reference herein. In an embodiment, the second model may be a Segment Anything Model (SAM) 2, which is described by Ravi et al., “Sam 2: Segment anything in images and videos,” arXiv: 2408.00714 (2024) and is incorporated by reference herein. The input video 702 may be processed by the open vocabulary video segmentation model 704 to generate the blob video parameters 706 (e.g., the ellipses). For example, the first model (e.g., the Grounding DINO and/or the ODISE model) may be selected to be used based on the underlying datasets associated with the input video 702. Subsequently, the first model may process the first frame of the input video 702 to obtain the segmentation masks for the first frame. Afterwards, using the segmentation masks of the first frame, the second model (e.g., the SAM 2 model) may process the remaining frames of the input video 702 to track the objects from the first frame and obtain the segmentation masks for the other frames of the input video 702. Subsequently, the open vocabulary video segmentation model 704 may include an ellipse fitting optimization algorithm to determine an ellipse for each segmentation mask in each frame of the input video 702. For instance, an ellipse may be fitted for each segmentation mask by optimizing the Intersection Over Union (IOU) between the ellipse and the mask area associated with the segmentation mask.

For example, the input video 702 may include a plurality of frames (e.g., one hundred frames), and each frame may indicate one or more objects (e.g., three objects). As such, the open vocabulary video segmentation model 704 may process each frame of the input video 702 to generate blob video parameters 706 for each frame. For instance, based on an example of the input video 702 having one hundred frames that each show three objects, the open vocabulary video segmentation model 704 may generate three blob video parameters 706 for each frame (e.g., three hundred total blob video parameters 706 for the input video 702), and each blob video parameter 706 may be a vector indicating the five variables described above (e.g., the center point of the ellipse, the radii of its semi-major and semi-minor axes, and the orientation angle of the ellipse). In other words, for an object that is shown within the input video 702, a blob parameter 706 may be generated for each frame of the input video 702.

To put it another way, given a video of frame length T, embodiments of the present disclosure may extract objects from the first frame (e.g., based on using the first model of the open vocabulary video segmentation model 704) and track each of the extracted objects in subsequent T−1 frames (e.g., based on using the second model of the open vocabulary video segmentation model 704). Accordingly, embodiments of the present disclosure may obtain a blob video of the same frame length that contains N blob ellipses in each frame (e.g., the blob video parameters 706 for each frame of the input video 702). Similar to BlobGEN that is described above, the n^{th} object's spatial features (including shape, size and location) in the t^{th} frame are depicted by blob parameters

$${τ}_{t}^{( n )} := [ {c}_{x} , {c}_{y} , a , b , θ ] ,$$

defined in the same way as described above for BlobGen. The blob video may capture how the spatial features of each object and their spatial arrangements evolve temporally. On one hand, it may easily capture the object motion in a natural video (e.g., a cat running on the grass), by looking into the relative movement of a blob (e.g., cat) to other blobs (e.g., grass). On the other hand, it may also capture the camera motion by referring to the joint movements and/or deformations of all blobs.

The blob video parameters 706 may be provided to the sub-sampling of frames block 708. For instance, while a blob parameter 706 may be generated for every object within each frame of the input video 702, the process 700 might not generate blob video descriptions for every object within each frame using the vision language model 710. For example, in some embodiments, generating blob video descriptions for every object within each frame might not be efficient in the data annotation stage nor convenient for users to construct during inference stage. In addition, consecutive frames in most videos have little change in the visual features of objects. Thus, in view of the above, process 700 may generate first blob video descriptions 712, which are only for a subset of the frames of the input video 702 (e.g., every few frames of the input video 702). As such, the sub-sampling frames block 708 may perform a sub-sampling to identify frames from the input video 702 to generate the first blob video descriptions 712. For example, in some embodiments, the sub-sampling frames block 702 may sample from the first and last frame of the input video 702 and one or more intermediate frames of the input video 702. For instance, the sub-sampling frames block 702 may use a sampling rate (e.g., sample every “k” frames such as every eight frames) to determine the subset of frames for the input video 702. For instance, based on a sampling rate and the input video 702 including one hundred total frames, the sub-sampling frame block 702 may determine a subset of frames that includes the first frame, the eighth frame, the sixteenth frame, and so on. After identifying the subset of frames, the sub-sampling frames block 702 may determine the blob video parameters 706 associated with the subset of frames (e.g., the blob video parameters 706 for the first frame, the eighth frame, and so on), and provide the blob video parameters 706 associated with the subset of frames to the vision language model 710.

Following, the blob video parameters 706 for the subset of frames and the input video 702 may be used by the vision language model 710 to generate the first blob video descriptions 712 for the subset of frames. In some embodiments, the vision language model 710 may be a standard vision language model such as a LLaVA model or a LLaVa-Next model. For instance, as mentioned above, the blob video parameters 706 may be determined based on the instance segmentation maps that are generated using the model(s) of the open vocabulary video segmentation model 704. Then, minimal bounding boxes that include the blob ellipses indicated by the blob video parameters 706 may be determined, and the minimal bounding boxes may be used to crop the associated frame from the input video 702. The cropped video frames may be fed to the vision language model 710 to generate the first blob video descriptions 712 (e.g., the blob captions for each of the blob video parameters 706) within the subset of frames that was determined by the sub-sampling frames block 708.

In summary, for the anchor frames (e.g., the subset of frames that was determined by the sub-sampling frames block 708), the blob video representations in the input video 702 are comprised of 1) blob video parameters 706

$$\{ {τ}_{t}^{( n )} \}$$

for every single frame (t=1, 2, . . . , T) and every single object (n=1, 2, . . . , N), and 2) first blob video descriptions 712

$$\{ {s}_{{t}_{k}}^{( n )} \}$$

for every k frame (tₖ=1, k+1, . . . , T) and every single object (n=1, 2, . . . , N). Particularly, the frames indexed by tₖ are denoted as anchor frames since they include both blob video parameters 706 and the first blob video descriptions 712. As will be described below, embodiments of the present disclosure obtain the complete context features for the other frames through context interpolations based on the first video blob descriptions 712 from the anchor frames. This configuration may offer consistent contextual information to avoid modality mismatch while applying the blob video representations.

For example, after generating the blob video parameters 706 and the first blob descriptions 712 for the input video 702, process 722 is performed to generate the second blob descriptions 716 and train the blob-grounded text-to-video diffusion model 718. For instance, given that only the first blob video descriptions 712 for a subset of frames is obtained using process 700, process 722 may include a context interpolation block 714 that generates second blob video descriptions 716 for the other frames of the input video 702 that are not the anchor frames. For example, as mentioned above, the first blob video descriptions 712 may be generated from the vision language model 710. Then, these first blob video descriptions 712 may be provided to the context interpolation block 714 and the context interpolation block 714 may process the first blob video descriptions 712 to generate the second blob video descriptions 716 for the other frames of the input video 702 (e.g., a second set of blob video descriptions 716 for the blob video parameters 706 within the other frames of the input video 702). In other words, the vision language model 710 may generate the first blob video descriptions 712 for a first set of frames of the input video 702 (e.g., blob video descriptions for the blob parameters 706 within the subset of frames determined by block 708) and the context interpolation block 714 may generate the second blob video descriptions 716 for the second set of frames of the input video 702 (e.g., blob video descriptions for the blob video parameters 706 within the remaining frames of the input video 702).

The context interpolation block 714 may utilize any context interpolation algorithm, method, and/or process to generate the second blob video descriptions 716 from the first blob video descriptions 712. For example, in some embodiments, the context interpolation block 714 may utilize linear interpolation to generate the embeddings of second blob video descriptions 716. In other words, based on two consecutive anchor frames (e.g., two consecutive frames from the subset of frames determined at block 708), the context interpolation block 714 may use linear interpolation to determine the embeddings of the second blob descriptions 716 for the frames in-between the two consecutive anchor frames. For instance, based on the first blob video descriptions 712 for the two consecutive anchor frames (e.g., the first and eighth frame of the input video 702 in the example above), linear interpolation may be utilized to determine the embeddings of the second blob video descriptions 716 for the intermediate frames (e.g., the second through seventh frames of the input video 702).

In other words, to obtain blob embeddings, BlobGEN may be followed to encode blob video representations for each single frame independently. That is, for the n^{th} object in the t^{th} frame, embodiments of the present disclosure may first obtain the blob parameter embedding

$${e}_{τ}^{t , n}$$

and blob description embedding

$${e}_{s}^{t , n} ,$$

and concatenate them along the embedding feature dimension as input to an multi-layer perceptron (MLP) network for its blob embedding

$${e}_{blob}^{t , n} .$$

However, not all frames are paired with blob captions, which means that after performing process 700, blob description embedding

$${e}_{s}^{t , n}$$

for those nonanchor frames whose frame index t≠tₖ are not yet known. As such, the context interpolation block 714 may be used to obtain these blob descriptions (e.g., the second blob video descriptions 716) that are then turned into the blob description embeddings.

In some examples, a naive approach is to encode an empty text string with CLIP text encoder and use it as the blob description embedding for all non-anchor frames (e.g., for the second set of frames of the input video 702). But, in some examples, this approach may introduce inconsistency across frames due to the large contextual mismatch. To overcome this issue, in some embodiments, the context interpolation block 714 may utilize context interpolation that linearly interpolates the blob description embeddings of two consecutive anchor frames for each non-anchor frame in the middle. Formally, given the indices of two anchor frames tₖ and tₖ₊₁ where tₖ₊₁=tₖ+k, the interpolated blob description embedding of the non-anchor frame indexed by t∈(tₖ, tₖ₊₁) is given by:

$${e}_{s}^{t , n} = \frac{{t}_{k + 1} - t}{k} {e}_{s}^{{t}_{k + 1} , n} + \frac{t - {t}_{k}}{k} {e}_{s}^{{t}_{k} , n}$$

Intuitively, this linear interpolation ensures a smooth semantic transitioning of object captions (e.g., the first and second blob video descriptions 712 and 716) across all frames in the CLIP embedding space, leading to better temporal consistency and blob-guided controllability.

Besides linear interpolation, in some embodiments, other approaches such as learnable non-linear interpolations may be used by the context interpolation block 714. For example, in some variations, the context interpolation block 714 may train and use a Perceiver-based model that takes the blob description embeddings of anchor frames as input and learns the blob descriptions embeddings of other frames. In other words, the context interpolation block 714 may utilize a Perceiver-based model to determine the embeddings of the second blob video descriptions 716. For example, the Perceiver-based model may process the first blob descriptions 712 for the two consecutive anchor frames (e.g., first and eight frame) to generate the embeddings of the second blob descriptions 716 for the intermediate frames (e.g., the second through seventh frames).

To put it another way, to ensure object-wise interpolation, the context interpolation block 714 may first reshape the context embeddings and then the Perceiver-based model may be used to obtain the second blob descriptions 716. In some instances, while the Perceiver-based model may originally have been proposed to handle inputs of different modalities, embodiments of the present disclosure may adopt it for the sake of simplicity and flexibility, as it allows an arbitrary number of anchor frames and facilitates handling the arbitrary number and locations of the anchor frames on users' choices in the future.

In other words, similar to BlobGEN described above, embodiments of the present disclosure may also pair the blob parameters 706 with blob descriptions (e.g., free-form text descriptions to provide fine-grained details of the local objects). Compared to conventional approaches that may use a single class label for each object across the frames, blob descriptions complement the spatial layout with more information such as appearance attributes (color, texture, etc.) and camera focus. Besides, since many visual features of an object may change in a video, it becomes very challenging to use a single blob video description to describe the object appearance and its dynamic variation across frames. Thus, embodiments of the present disclosure opt to apply multiple frame-wise object captions for each blob, which are independently extracted from an existing image captioning model. However, embodiments of the present disclosure might not apply blob descriptions to every object in every single frame because 1) it is neither efficient in the data annotation stage nor convenient for users to construct during inference, and 2) consecutive frames in most videos have little change in objects' visual features. Instead, embodiments of the present disclosure may assign blob descriptions at a fixed interval across time, spacing them every k frames (e.g., obtain the first blob descriptions 712) and then may use the context interpolation block 714 to obtain blob descriptions for the remaining frames (e.g., obtain the second blob descriptions 716).

The blob video parameters 706, the first blob video descriptions 712 from the vision language model 710, and the second blob video descriptions 716 from the context interpolation block 714 are provided to the blob-grounded text-to-video diffusion model 718. The blob-grounded text-to-video diffusion model 718 may be a modified diffusion model that generates the output video 720 using the blob video parameters 706, the first blob video descriptions 712, and the second blob video descriptions 716. In other words, the blob video parameters 706, the first blob video descriptions 712, and the second blob video descriptions 716 may be utilized by the blob-grounded text-to-video diffusion model 718 as grounding inputs to guide the generation process for generating the output video 720. A standard diffusion model loss may be determined based on comparing the output video 720 to the input video 702, and the loss may be used to train the blob-grounded text-to-video diffusion model 718. The architecture and training for the blob-grounded text-to-video diffusion model 718 is described in further detail in FIG. 7B.

For example, FIG. 7B shows a portion 730 of a training process 722 of the general overview of FIG. 7A, in accordance with one or more embodiments of the present disclosure. Specifically, FIG. 7B shows the portion 730 of the training process 722 after the second blob video descriptions 716 are generated by the context interpolation block 714.

In an embodiment, the blob-grounded text-to-video diffusion model 718 may be a modified pre-trained text-to-video diffusion model. In particular, the blob-grounded text-to-video diffusion model 718 may include an encoder 742 and a decoder 748. Between the encoder 742 and the decoder 748, the blob-grounded text-to-video diffusion model 718 may include a blob-grounded backbone 744 that includes blob-grounded attention layers 746. In operation, the Gaussian noise 740 may be provided to the encoder 742, and the encoder output is provided to the blob-grounded backbone 744. In addition, grounding inputs such as the blob video parameters 706, the first blob video descriptions 712, and the second blob video descriptions 716 may be provided to the blob-grounded backbone 744. Based on the inputs, the blob-grounded backbone 744 may generate and provide a backbone output to the decoder 748. The decoder 748 may process the backbone output and generate the output video 720.

In some examples, the blob-grounded text-to-video diffusion model 718 may be a modified stable diffusion model that includes an encoder 742 and a decoder 748 with a U-Net backbone in-between the encoder 742 and decoder 748 (e.g., the blob-grounded backbone 744 may be and/or include a U-Net). In the blob-grounded text-to-video diffusion model 718, the encoder 742 and the decoder 748 might not be modified from the standard stable diffusion model, but the blob-grounded backbone 744 (e.g., the U-Net backbone) may be modified to include blob-grounded attention layers 746. The blob-grounded attention layers 746 may be provided the blob video parameters 706, the first blob video descriptions 712, and/or the second blob video descriptions 716 as grounding input for the video generation. The blob-grounded backbone 744 (e.g., the U-Net backbone) and the blob-grounded attention layers 746 are described in further detail in FIG. 7C.

FIG. 7C shows exemplary layers 750 of a blob-grounded backbone 744 of the blob-grounded text-to-video diffusion model 718, in accordance with one or more embodiments of the present disclosure. In particular, FIG. 7C shows exemplary layers 750 of the blob-grounded backbone 744 when the blob-grounded text-to-video diffusion model 718 is a modified stable diffusion model that includes a U-Net backbone.

For example, a standard U-Net backbone may include a plurality of spatial cross-attention layers 754 and a plurality of temporal self-attention layers 758. In the blob-grounded backbone 744, two blob-grounded attention layers 746 (e.g., a masked spatial cross-attention layer 756 and a masked 3D self-attention layer 760) may be included for each spatial cross-attention layer 754 and temporal self-attention layer 758. For instance, caption tokens and visual tokens may be provided to a traditional spatial cross-attention layer 754 to generate a spatial output. Instead of providing the spatial output directly to a traditional temporal self-attention layer 758, the blob-grounded backbone 744 includes a masked spatial cross-attention layer 756 that utilizes the blob video representations 752 (e.g., the blob video parameters 706, the first blob video descriptions 712, and the second blob video descriptions 716) as grounding input. The masked spatial cross-attention layer 756 may process the spatial output and the blob video representations 752 to generate a masked spatial cross-attention output that is provided to the temporal self-attention layer 758. The temporal self-attention layer 758 may generate a temporal output. But, instead of providing the temporal output to the next layer of the blob-grounded backbone 744 (or providing the output to the decoder 748), the blob-grounded backbone 744 further includes a masked 3D self-attention layer 760 that processes the temporal output to generate a masked 3D self-attention layer output that is then provided onwards. In other words, traditional U-Net backbones may include spatial cross-attention layers 754 and temporal self-attention layers 758. In contrast, to utilize the blob video representations 752, the blob-grounded backbone 744 (e.g., a blob-grounded U-Net backbone) may further include a masked spatial cross-attention layer 756 and a masked 3D self-attention layer 760 for each of the spatial cross-attention layers 754 and temporal self-attention layers 758. The functionality of the masked spatial cross-attention layer 756 and the masked 3D self-attention layer 760 are described in further detail below.

For instance, the masked spatial cross-attention layer 756 may perform a similar functionality to the masked cross attention layer 158 of FIG. 1D above except that it may further perform a reshaping process for the visual features (e.g., the spatial output from the spatial cross-attention layer 754) and the blob embeddings (e.g., the embeddings associated with the blob video representations 752). For example, because the blob video representations 752 are for a plurality of frames of the input video 702, the blob video representations 752 may further indicate extra temporal information. As such, the masked spatial cross-attention layer 756 may begin by fusing the blob embeddings and the visual features in the same frame independently for all the frames.

For example, for each frame, the visual features for the frame and the blob embeddings for the frame (e.g., the blob video parameters 706 and the first or second blob video descriptions 712 or 716 for the frame) may be fused together to obtain fused embeddings. A plurality of fused embeddings may be obtained for the plurality of frames of the input video 702. Subsequently, the masked spatial cross-attention layer 756 may perform masked cross-attention, which is described in FIG. 1D above, on the fused embeddings to obtain the masked spatial cross-attention output that is then provided to the temporal self-attention layer 758. By using this functionality, the masked spatial cross-attention layer 756 may focus solely on promoting the frame-wise alignment of generated content and the blob conditioning, without worrying about temporal consistency.

In other words, the extension of the masked spatial cross-attention layer 756 from the masked cross-attention layer 158 from BlobGEN to fuse blob video representations 752 with video features is straightforward. In some examples, both the visual features and blob embeddings may first reshaped and then they may be fused by applying the masked cross-attention equation described above in FIG. 1D. That is, embodiments of the present disclosure may fuse the blob embeddings and visual features in the same frame independently for all the frames. This configuration may allow the masked spatial cross-attention layers 756 to solely focus on promoting the frame-wise alignment of generated content and the blob conditioning, without worrying about temporal consistency.

In some embodiments, prior to the masked spatial cross-attention layer 756 utilizing the blob video representations 752, one or more encoders may be used to embed the blob parameters 706 and the blob descriptions 712 and 716 into blob tokens (e.g., blob embeddings). The blob tokens/embeddings are then provided to the masked spatial cross-attention layer 756. This is described in further detail above.

While the masked spatial cross-attention layer 756 applies per-frame consistency between frames and blobs embeddings, the masked spatial cross-attention layer 756 may be unable to guarantee temporal consistency across the frames. As such, to improve the temporal consistency, the masked 3D self-attention layer 760 may be used. For example, the input video 702 may show positional and/or other changes to the same objects across different frames (e.g., the input video 702 may show a cat jumping from the ground onto a couch). The masked 3D self-attention layer 760 may be utilized to have an object (e.g., the cat in the first frame, which may be located on the ground) in one frame to attend to the same object in other frames of the input video 702 (e.g., the cat in the other frames where the cat may be shown to jump on the couch).

In other words, to perform masked 3D self-attention, the three dimensions of a video feature (e.g., denoted as time (T), heigh (h), and width (w)) may be flattened into one dimension to obtain a resulting feature. Then, three linear projections for self-attention may be performed to obtain a query, key, and value. Following, binary blob masks for the objects (e.g., the cat) within the frames of the input video 702 and background masks associated with the background within the frames of the input video 702 may be obtained. Utilizing the query, key, and value as well as the binary blob masks and background masks, the masked 3D self-attention may be performed such that a local object feature for a particular frame may only attend to local features of the same object for another frame. In addition, the background features may attend only to other background features across all frames. As such, the masked 3D self-attention layer 760 may utilize an object-centric self-attention mechanism and/or implementation, which may lead to better object-level cross-frame consistency.

To put it another way, the masked spatial cross-attention performed by the masked spatial cross-attention layer 756 may apply per-frame consistency between frames and blobs but might not be able to guarantee temporal consistency across frames. To improve temporal consistency, embodiments of the present disclosure may use the masked 3D self-attention layers 760 to enforce object-level temporal consistency. It may be noted that even though many video diffusion models based on U-Net are equipped with temporal self-attention, these traditional temporal self-attention layers only allow each “pixel” of the visual feature map in a frame to attend to “pixels” at the same spatial location in other frames. However, blobs provide a rough location of each object over time, and thus stronger coherence may be imposed by biasing the attention towards the same object over time.

Specifically, in masked 3D self-attention that is performed by the masked 3D self-attention layers 760, all three dimensions in a video feature (e.g., T, h, w) may be flattened into one dimension and the resulting feature may be denoted as g∈ [symbol] ^{Thw×d}. Then, query, key, and value may be obtained with three linear projections for self-attention as q=gW_{q}, k=gWₖ, V=gWᵥ, all in the shape of [symbol] ^{Thw×d}. Following, the masked 3D self-attention may be expressed as:

$$MaskSA 3 D := Softmax ( \frac{{qk}^{T}}{\sqrt{d}} + {M}_{blob} ) v ,$$

where M_{blob}∈ [symbol] ^{Thw×Thw} is a 3D mask determined by blob ellipses across frames, which is described next.

For instance, similar to BlobGEN, the binary blob mask for the n^{th} object in the t^{th} frame may be denoted as m^{t,n}∈ [symbol] ^{hw}, where its i^{th} entry

$$( denoted as {m}_{i}^{t , n} )$$

equals 1 if the location i is within the blob ellipse, and 0 otherwise. Besides the N blob masks corresponding to N objects in each frame, embodiments of the present disclosure may introduce another binary mask, called a background mask, as

$${m}^{t , bg} = 1 - {⋃}_{n = 1}^{N} {m}^{t , n} ,$$

resulting in N+1 blob masks that cover the whole (h×w) spatial space. Given any two indices i, j∈{1, 2, . . . , Thw}, embodiments of the present disclosure may then define each entry of M_{blob} indexed by (i, j) as:

$${M}_{blob}^{i , j} = \{ \begin{matrix}0 & if {m}_{i}^{t , n} ⋀ {m}_{j}^{{t}^{′} , n} = 1 , ∀ t , {t}^{′} , n \\ 0 & if {m}_{i}^{t , bg} ⋀ {m}_{j}^{{t}^{′} , bg} = 1 , ∀ t , {t}^{′} \\ - ∞ & otherwise\end{matrix}$$

which allows the local object feature for the t frame (depicted by a blob ellipse) to only attend to local features of the same object for another frame (including the t frame itself). Note that each background feature may only attend to other background features across frames. Thus, this 3D mask configuration may imply an object-centric self-attention mechanism, leading to better object-level cross-frame consistency. Furthermore, the use of m^{t,bg} may be critical in practical implementation to avoid having all-zero rows in the input to the softmax function and improve training stability.

In some examples, the masked 3D self-attention layer 760 may be located after the masked spatial cross-attention layer 756 to create a bottleneck for the context feature fusion.

As mentioned previously, the blob-grounded backbone 744, which may be a U-Net backbone in the above embodiment, may include multiple spatial cross-attention layers 754 and temporal self-attention layers 758. Therefore, for each spatial cross-attention layer 754 and temporal self-attention layer 758, the blob-grounded backbone 744 may include a masked spatial cross-attention layer 756 and a masked 3D self-attention layer 760.

In other embodiments, the blob-grounded text-to-video diffusion model 718 may include and/or be associated with a blob-grounded backbone 744 that is a diffusion transformer (DiT) backbone. For instance, referring to FIG. 7B, the blob-grounded text-to-video diffusion model 718 may still include an encoder 742 and a decoder 748, but the blob-grounded backbone 744 may include and/or be associated with a DiT. For example, a traditional DiT backbone may include a plurality of 3D self-attention layers. For each of the plurality of 3D self-attention layers, the blob-grounded backbone 744 may include blob-grounded attention layers 746 such as the masked spatial cross-attention layer 756 and the masked 3D self-attention layer 760. This is shown in FIG. 7D.

FIG. 7D shows exemplary layers 770 of another blob-grounded backbone 744 of the blob-grounded text-to-video diffusion model 718, in accordance with one or more embodiments of the present disclosure. For example, a standard DiT backbone may include a plurality of 3D self-attention layers 772. In the blob-grounded backbone 744, two blob-grounded attention layers 746 (e.g., a masked spatial cross-attention layer 756 and a masked 3D self-attention layer 760) may be included for each 3D self-attention layer 772. For instance, caption tokens and visual tokens may be provided to a traditional 3D self-attention layer 772 to generate a self-attention output (e.g., output caption tokens and visual tokens). The output visual tokens from the traditional 3D self-attention layer 772 may be provided to the masked spatial cross-attention layer 756 along with the blob video representations 752 (e.g., embeddings of the blob video parameters 706, the first blob video descriptions 712, and the second blob video descriptions 714). The masked spatial cross-attention layer 756 may process the output visual tokens and the blob video representations 752 to generate a masked spatial cross-attention output and provide the masked spatial cross-attention output to the masked 3D self-attention layer 760. The masked 3D self-attention layer 760 may obtain the masked spatial cross-attention output and the caption token output from the 3D self-attention layer 772, and may process the outputs to generate a masked 3D self-attention output that is then provided onwards. The functionality of the masked spatial cross-attention layer 756 and the masked 3D self-attention layer 760 for when the blob-grounded backbone 744 is a DiT backbone may be similar to the masked spatial cross-attention layer 756 and the masked 3D self-attention layer 760 for when the blob-grounded backbone 744 is a U-Net backbone, which is described in further detail above.

In some embodiments, returning back to FIG. 7A, for the training process 722, the blob-grounded text-to-video diffusion model 718 may begin as a pre-trained diffusion model (e.g., a pre-trained diffusion model that includes a U-Net backbone or a DiT backbone). Then, the weights of the pre-trained diffusion model (e.g., the encoder 742, the decoder 748, and/or the blob-grounded backbone 744 other than the blob-grounded attention layers 746) may be frozen, and only the newly added layers (e.g., the masked spatial cross-attention layers 756 and the masked 3D self-attention layers 760) may be trained. Thus, the diffusion loss may be determined based on comparing the output video 720 and the input video 702, and the diffusion loss may be used to train only the weights of the masked spatial cross-attention layer 756 and the masked 3D self-attention layer.

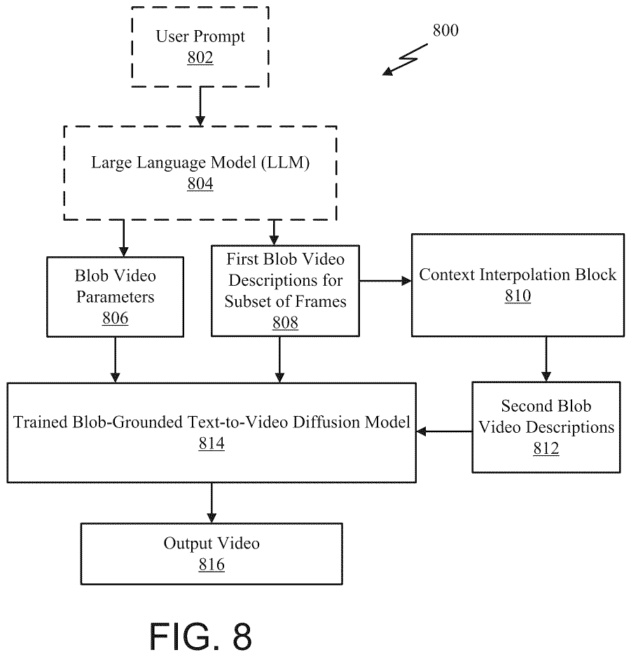

FIG. 8 illustrates a block diagram showing an inference phase 800 of using the trained blob-grounded text-to-video diffusion model 814 to generate an output video 816, in accordance with one or more embodiments of the present disclosure. Similar to FIG. 2A above, the large language model (LLM) 804 and the user prompt 802 are denoted as dashed lines to show that they are optional.

For example, in embodiments without the user prompt 802 and the LLM 804, a user may provide the blob video parameters 806 and the first blob video descriptions for a subset of frames 808 to the trained blob-grounded text-to-video diffusion model 814. In addition, to obtain the second blob video descriptions for the other frames 812, the context interpolation block 810 may be used. For instance, the context interpolation block 810 may function similarly to the context interpolation block 714 from FIG. 7A (e.g., the context interpolation block 810 may use linear interpolation or a Perceiver-based model to generate the second blob video descriptions 812). The second blob video descriptions 812 may also be provided to the trained blob-grounded text-to-video diffusion model 814.

Based on the inputs, the trained blob-grounded text-to-video diffusion model 814 generates the output video 816. Additionally, and/or alternatively, users may be able to manipulate either the blob video parameters 806 and/or the first blob video descriptions 808 such as by adjusting one or more parameters from the blob video parameters 806. Thus, based on manually adjusting the blob video parameters 806 and/or the first blob video descriptions 808, the trained blob-grounded text-to-video diffusion model 814 may be able to account for the user manipulations and generate output videos 816 that reflect the user manipulations.

In some embodiments, the LLM 804 may be utilized to generate the blob video parameters 806 and the first blob video descriptions 808 from the user prompt 802. For example, initially, one or more system prompts may be generated and then provided to the LLM 804 to instruct the LLM 804 on how to generate the blob video parameters 806 and the first blob video descriptions 808. After providing the system prompt to instruct the LLM 804, the LLM 804 may be provided a user prompt 802, and the LLM 804 may generate the blob video parameters 806 and the first blob video descriptions 808 based on the user prompt 802.

In some examples, embodiments of the present disclosure may generate video layouts with in-context learning and structured text. Since video layouts may need to expand over the time dimension and may have multiple objects per frame, it may be important to find a robust structure to represent them. Instead of using a self-defined template or stylesheet language, embodiments of the present disclosure may form the layouts as nested dictionaries where frame index, object identifier (ID), blob parameters and descriptions (e.g., the blob video parameters 806 and the blob video descriptions 808 and 812) are settled in different layers of the structure. LLMs (e.g., the LLM 804) may interpret and generate outputs in the same JAVASCRIPT Object Notation (JSON) format that may be directly parsed into blob layouts per frame. In addition, embodiments of the present disclosure may only generate blobs for a sparse set of frames (e.g., the first blob video descriptions for the subset of frames 808) while interpolate the intermediate blob parameters (e.g., use the context interpolation block 810 to generate the second blob video descriptions 812) to make the stage more efficient.

Among other benefits and advantages, embodiments of the present disclosure provide a blob-grounded text to-video diffusion model 718 that includes a blob-grounded backbone 744. The blob-grounded backbone 744 includes blob-grounded attention layers 746 such as a masked spatial cross-attention layer 756 and a masked 3D self-attention layer 760, which are described above. Additionally, and/or alternatively, in some embodiments, the blob-grounded backbone 744 is and/or includes a U-Net backbone and in other embodiments, the blob-grounded backbone 744 is and/or includes a DiT backbone. Additionally, and/or alternatively, the blob-grounded text to-video diffusion model 718 utilizes blob video parameters 706, first blob video descriptions 712, and second blob video descriptions 716. A context interpolation block 714 generates the second blob video descriptions 716 based on the first blob video descriptions 712. Additionally, and/or alternatively, the vision language model 710 does not generate blob video descriptions for all of the blob video parameters 706 within all of the frames of the input video 702. Instead, a sub-sampling frames block 708 is utilized to determine a subset of frames within the input video 702. Following, the vision language model 710 generates first blob video descriptions for the blob video parameters 706 within the subset of frames. Subsequently, the context interpolation block 714 generates second blob video descriptions for the blob video parameters 706 for the remaining frames within the input video 702.

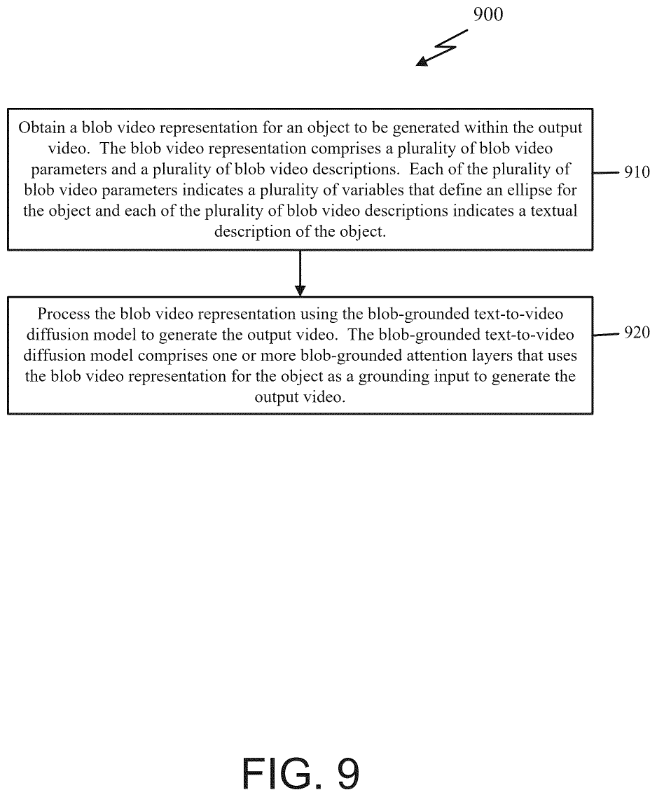

FIG. 9 illustrates a flowchart of a method 900 for using a blob-grounded text-to-video diffusion model to generate an output video, in accordance with an embodiment. Each block of method 900, described herein, comprises a computing process that may be performed using any combination of hardware, firmware, and/or software. For instance, various functions may be carried out by a processor executing instructions stored in memory. The method 900 may also be embodied as computer-usable instructions stored on computer storage media. The method 900 may be provided by a standalone application, a service or hosted service (standalone or in combination with another hosted service), or a plug-in to another product, to name a few. In addition, method 900 is described, by way of example, with respect to the blob-grounded text-to-video diffusion model 718 of FIG. 7A and the trained blob-grounded text-to-video diffusion model 814 of FIG. 8. However, the method 900 may additionally or alternatively be executed by any one system, or any combination of systems, including, but not limited to, those described herein. Furthermore, persons of ordinary skill in the art will understand that any system that performs method 900 is within the scope and spirit of embodiments of the present disclosure.

At step 910, a blob video representation for an object to be generated within the output video may be obtained. The blob video representation may comprise a plurality of blob video parameters and a plurality of blob video descriptions. Each of the plurality of blob video parameters may indicate a plurality of variables that define an ellipse for the object and each of the plurality of blob video descriptions may indicate a textual description of the object.

At step 920, the blob video representation may be processed using the blob-grounded text-to-video diffusion model to generate the output video. The blob-grounded text-to-video diffusion model comprises one or more blob-grounded attention layers that uses the blob video representation for the object as a grounding input to generate the output video.

In an embodiment, the method 900 further includes training the blob-grounded text-to-video diffusion model using training data comprising a training input video. In an embodiment, training the blob-grounded text-to-video diffusion model comprises: processing the training input video using an open vocabulary video segmentation model to generate a plurality of training blob parameters; processing a subset of the plurality of training blob parameters using a vision language model to generate first video descriptions for the subset of the plurality of training blob parameters; generating a training output video based on the blob-grounded text-to-video diffusion model, the plurality of training blob parameters, and the first video descriptions; and training the blob-grounded text-to-video diffusion model based on comparing the training output video with the training input video.

In an embodiment, training the blob-grounded text-to-video diffusion model further comprises: determining a subset of a plurality of frames within the training input video; separating the plurality of training blob parameters into the subset of the plurality of training blob parameters and a second subset of the plurality of training blob parameters based on the subset of the plurality of frames; and performing context interpolation to generate second video descriptions for the second subset of the plurality of training blob parameters based on the first video descriptions, and wherein generating the training output video is further based on the second video descriptions.

In an embodiment, determining the subset of the plurality of frames within the training input video comprises: identifying a first anchor frame associated with a first frame from the plurality of frames within the training input video; identifying a second anchor frame associated with a second frame from the plurality of frames within the training input video, wherein in-between the first frame and the second frame comprises one or more intermediate frames from the plurality of frames within the training input video; and populating the subset of the plurality of frames with the first anchor frame and the second anchor frame, wherein the first video descriptions comprises video descriptions associated with the first anchor frame and the second anchor frame.

In an embodiment, performing the context interpolation comprises: generating the second video descriptions for the one or more intermediate frames based on linearly interpolating between the video descriptions associated with the first anchor frame and the second anchor frame.

In an embodiment, performing the context interpolation comprises: processing the video descriptions associated with the first anchor frame and the second anchor frame using a Perceiver-based model to generate the second video descriptions for the one or more intermediate frames.

In an embodiment, the blob-grounded text-to-video diffusion model comprises an encoder, a decoder, and a blob-grounded backbone that comprises a U-Net backbone, wherein the U-Net backbone comprises a plurality of blob-grounded attention layers. In an embodiment, the plurality of blob-grounded attention layers comprises a masked spatial cross-attention layer, and wherein processing the blob video representation using the blob-grounded text-to-video diffusion model to generate the output video comprises: processing embeddings associated with the blob video representation and a spatial cross-attention output from a spatial cross-attention layer using the masked spatial cross-attention layer to generate a masked spatial cross-attention output; and generating the output video based on the masked spatial cross-attention output.

In an embodiment, the plurality of blob-grounded attention layers further comprises a masked three-dimensional (3D) self-attention layer, and processing the blob video representation using the blob-grounded text-to-video diffusion model to generate the output video further comprises: processing the masked spatial cross-attention output using a temporal self-attention layer to generate a temporal output; and processing the temporal output with the masked 3D self-attention layer to generate a masked 3D self-attention output, wherein generating the output video is further based on the masked 3D self-attention output.

In an embodiment, the blob-grounded text-to-video diffusion model comprises a blob-grounded backbone that comprises a diffusion transformer (DiT) backbone, wherein the DiT backbone comprises a plurality of blob-grounded attention layers. In an embodiment, the plurality of blob-grounded attention layers comprises a masked spatial cross-attention layer and a masked three-dimensional (3D) self-attention layer, and processing the blob video representation using the blob-grounded text-to-video diffusion model to generate the output video comprises: processing embeddings associated with the blob video representation and a 3D self-attention layer output from a 3D self-attention layer using the masked spatial cross-attention layer to generate a masked spatial cross-attention output; processing the masked spatial cross-attention output using the masked 3D self-attention layer to generate a masked 3D self-attention output; and generating the output video based on the masked 3D self-attention output.

In an embodiment, the method 900 further comprises obtaining a request to generate the output video, wherein the request comprises a user prompt, and wherein obtaining the blob video representation comprises: generating the plurality of blob video parameters and the plurality of blob video descriptions based on processing the user prompt using one or more large language models (LLMs).

In an embodiment, generating the plurality of blob video parameters and the plurality of blob video descriptions comprises: generating the plurality of blob video parameters and a first subset of the plurality of blob video descriptions using the user prompt and the one or more LLMs; and generating a second subset of the plurality of blob video descriptions based on performing context interpolation of the first subset of the plurality of blob video descriptions.

In an embodiment, at least one of steps 910 and 920 and/or the further steps described above for method 900 are performed on a server or in a data center to train the blob-grounded text-to-video diffusion model 718 and/or use the trained grounded text-to-video diffusion model 814 to generate the output video 816, and the output video 816 is streamed to a user device. In an embodiment, at least one of steps 910 and 920 and/or the further steps described above for method 900 is performed within a cloud computing environment. In an embodiment, at least one of steps 910 and 920 and/or the further steps described above for method 900 is performed for training, testing, or certifying a neural network employed in a machine, robot, or autonomous vehicle. In an embodiment, at least one of steps 910 and 920 and/or the further steps described above for method 900 is performed on a virtual machine comprising a portion of a graphics processing unit.

In some examples, during training, embodiments of the present disclosure may decompose videos into visual primitives such as blob video representations, which may be general representations for controllable video generation. Based on the blob video representations (e.g., the blob video parameters 706 and descriptions 712 and 716), a blob-grounded text-to-video diffusion model 718 may be developed. In some examples, the blob-grounded text-to-video diffusion model 718 may permit users to control object motions and fine-grained object appearance. Additionally, and/or alternatively, the blob-grounded text-to-video diffusion model 718 may include masked 3D self-attention layers 760 and/or masked spatial cross-attention layers 756 that effectively improves regional consistency across frames. Additionally, and/or alternatively, embodiments of the present disclosure may utilize context interpolation (e.g., a context interpolation block 714) that may interpolate text embeddings such that users may control semantics in specific frames and obtain smooth object transitions. Additionally, and/or alternatively, the blob-grounded text-to-video diffusion model 718 may be model-agnostic. For instance, the blob-grounded text-to-video diffusion model 718 may include a backbone 744 that is and/or includes a U-Net and/or a diffusion transformer (DiT). After conducting extensive experimental results, it was shown that the blob-grounded text-to-video diffusion model 718 described by embodiments of the present disclosure achieves superior zero-shot video generation ability and state-of-the-art layout controllability on multiple benchmarks. Furthermore, when combined with an LLM 804 for layout planning, it was shown that the trained blob-grounded text-to-video diffusion model 814 even outperforms proprietary text-to-video generators in terms of compositional accuracy.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for using a blob-grounded text-to-video diffusion model to generate an output video, comprising:
obtaining a blob video representation for an object to be generated within the output video, wherein the blob video representation comprises a plurality of blob video parameters and a plurality of blob video descriptions, wherein each of the plurality of blob video parameters indicates a plurality of variables that define an ellipse for the object and each of the plurality of blob video descriptions indicates a textual description of the object; and
processing the blob video representation using the blob-grounded text-to-video diffusion model to generate the output video, wherein the blob-grounded text-to-video diffusion model comprises one or more blob-grounded attention layers that uses the blob video representation for the object as a grounding input to generate the output video.

2. The computer-implemented method of claim 1, further comprising:
training the blob-grounded text-to-video diffusion model using training data comprising a training input video.

3. The computer-implemented method of claim 2, wherein training the blob-grounded text-to-video diffusion model comprises:
processing the training input video using an open vocabulary video segmentation model to generate a plurality of training blob parameters;
processing a subset of the plurality of training blob parameters using a vision language model to generate first video descriptions for the subset of the plurality of training blob parameters;
generating a training output video based on the blob-grounded text-to-video diffusion model, the plurality of training blob parameters, and the first video descriptions; and
training the blob-grounded text-to-video diffusion model based on comparing the training output video with the training input video.

4. The computer-implemented method of claim 3, wherein training the blob-grounded text-to-video diffusion model further comprises:
determining a subset of a plurality of frames within the training input video;
separating the plurality of training blob parameters into the subset of the plurality of training blob parameters and a second subset of the plurality of training blob parameters based on the subset of the plurality of frames; and
performing context interpolation to generate second video descriptions for the second subset of the plurality of training blob parameters based on the first video descriptions, and
wherein generating the training output video is further based on the second video descriptions.

5. The computer-implemented method of claim 4, wherein determining the subset of the plurality of frames within the training input video comprises:
identifying a first anchor frame associated with a first frame from the plurality of frames within the training input video;
identifying a second anchor frame associated with a second frame from the plurality of frames within the training input video, wherein in-between the first frame and the second frame comprises one or more intermediate frames from the plurality of frames within the training input video; and
populating the subset of the plurality of frames with the first anchor frame and the second anchor frame, wherein the first video descriptions comprises video descriptions associated with the first anchor frame and the second anchor frame.

6. The computer-implemented method of claim 5, wherein performing the context interpolation comprises:
generating the second video descriptions for the one or more intermediate frames based on linearly interpolating between the video descriptions associated with the first anchor frame and the second anchor frame.

7. The computer-implemented method of claim 5, wherein performing the context interpolation comprises:
processing the video descriptions associated with the first anchor frame and the second anchor frame using a Perceiver-based model to generate the second video descriptions for the one or more intermediate frames.

8. The computer-implemented method of claim 1, wherein the blob-grounded text-to-video diffusion model comprises an encoder, a decoder, and a blob-grounded backbone that comprises a U-Net backbone, wherein the U-Net backbone comprises a plurality of blob-grounded attention layers.

9. The computer-implemented method of claim 8, wherein the plurality of blob-grounded attention layers comprises a masked spatial cross-attention layer, and wherein processing the blob video representation using the blob-grounded text-to-video diffusion model to generate the output video comprises:
processing embeddings associated with the blob video representation and a spatial cross-attention output from a spatial cross-attention layer using the masked spatial cross-attention layer to generate a masked spatial cross-attention output; and
generating the output video based on the masked spatial cross-attention output.

10. The computer-implemented method of claim 9, wherein the plurality of blob-grounded attention layers further comprises a masked three-dimensional (3D) self-attention layer, and wherein processing the blob video representation using the blob-grounded text-to-video diffusion model to generate the output video further comprises:
processing the masked spatial cross-attention output using a temporal self-attention layer to generate a temporal output; and
processing the temporal output with the masked 3D self-attention layer to generate a masked 3D self-attention output, wherein generating the output video is further based on the masked 3D self-attention output.

11. The computer-implemented method of claim 1, wherein the blob-grounded text-to-video diffusion model comprises a blob-grounded backbone that comprises a diffusion transformer (DiT) backbone, wherein the DiT backbone comprises a plurality of blob-grounded attention layers.

12. The computer-implemented method of claim 11, wherein the plurality of blob-grounded attention layers comprises a masked spatial cross-attention layer and a masked three-dimensional (3D) self-attention layer, and wherein processing the blob video representation using the blob-grounded text-to-video diffusion model to generate the output video comprises:
processing embeddings associated with the blob video representation and a 3D self-attention layer output from a 3D self-attention layer using the masked spatial cross-attention layer to generate a masked spatial cross-attention output;
processing the masked spatial cross-attention output using the masked 3D self-attention layer to generate a masked 3D self-attention output; and
generating the output video based on the masked 3D self-attention output.

13. The computer-implemented method of claim 1, further comprising:
obtaining a request to generate the output video, wherein the request comprises a user prompt, and
wherein obtaining the blob video representation comprises:
generating the plurality of blob video parameters and the plurality of blob video descriptions based on processing the user prompt using one or more large language models (LLMs).

14. The computer-implemented method of claim 13, wherein generating the plurality of blob video parameters and the plurality of blob video descriptions comprises:
generating the plurality of blob video parameters and a first subset of the plurality of blob video descriptions using the user prompt and the one or more LLMs; and
generating a second subset of the plurality of blob video descriptions based on performing context interpolation of the first subset of the plurality of blob video descriptions.

15. The computer-implemented method of claim 1, wherein at least one of the steps of obtaining and processing are performed on a server or in a data center to generate the output video, and the output video is streamed to a user device.

16. The computer-implemented method of claim 1, wherein at least one of the steps of obtaining and processing are performed within a cloud computing environment.

17. The computer-implemented method of claim 1, wherein at least one of the steps of obtaining and processing are performed for training, testing, or certifying a neural network employed in a machine, robot, or autonomous vehicle.

18. The computer-implemented method of claim 1, wherein at least one of the steps of obtaining and processing is performed on a virtual machine comprising a portion of a graphics processing unit.

19. A system for using a blob-grounded text-to-video diffusion model to generate an output video, comprising:
one or more processors; and
a non-transitory computer-readable medium having processor-executable instructions stored thereon, wherein the processor-executable instructions, when executed by the one or more processors, facilitate:
obtaining a blob video representation for an object to be generated within the output video, wherein the blob video representation comprises a plurality of blob video parameters and a plurality of blob video descriptions, wherein each of the plurality of blob video parameters indicates a plurality of variables that define an ellipse for the object and each of the plurality of blob video descriptions indicates a textual description of the object; and
processing the blob video representation using the blob-grounded text-to-video diffusion model to generate the output video, wherein the blob-grounded text-to-video diffusion model comprises one or more blob-grounded attention layers that uses the blob video representation for the object as a grounding input to generate the output video.

20. The system of claim 19, wherein the processor-executable instructions, when executed by the one or more processors, further facilitate:
training the blob-grounded text-to-video diffusion model using training data comprising a training input video.

21. A non-transitory computer-readable medium having processor-executable instructions stored thereon for using a blob-grounded text-to-video diffusion model to generate an output video, wherein the processor-executable instructions, when executed, facilitate:
obtaining a blob video representation for an object to be generated within the output video, wherein the blob video representation comprises a plurality of blob video parameters and a plurality of blob video descriptions, wherein each of the plurality of blob video parameters indicates a plurality of variables that define an ellipse for the object and each of the plurality of blob video descriptions indicates a textual description of the object; and
processing the blob video representation using the blob-grounded text-to-video diffusion model to generate the output video, wherein the blob-grounded text-to-video diffusion model comprises one or more blob-grounded attention layers that uses the blob video representation for the object as a grounding input to generate the output video.

22. The non-transitory computer-readable medium of claim 21, wherein the processor-executable instructions, when executed, further facilitate:
training the blob-grounded text-to-video diffusion model using training data comprising a training input video.
